(19) United States
(12) Patent Application Publication
(10) Pub. No.: US 2017/0131442 A1
(43) Pub. Date: May 11, 2017

(54) MARKER COMPOSITION AND PACKAGE

(71) Applicant: 3M INNOVATIVE PROPERTIES COMPANY, St. Paul, MN (US)

(72) Inventors: Shunsuke Takaki, Sagamihara (JP); Giuseppe M. Bommarito, Stillwater, MN (US)

(21) Appl. No.: 15/319,320

(22) PCT Filed: Jun. 17, 2015
(86) PCT No.: PCT/US2015/036147

§ 371 Date: Dec. 15, 2016

Related U.S. Application Data
(60) Provisional application No. 62/016,805, filed on Jun. 25, 2014.

(51) Int. Cl. G02B 5/124; B65D 75/58; B29D 11/00; B65D 75/36

(52) U.S. Cl. CPC G02B 5/124; B65D 75/367; B65D 75/5855; B29D 11/00605; B29K 2029/00

(57) ABSTRACT

A marker composition and a package using same. The marker composition can include retroreflective particles and a dispersion medium, the blending ratio of the retroreflective particles being from 50 to 90 mass % on the basis of the total marker composition.

### FIELD

The present invention relates to a marker composition and a package.

### BACKGROUND

U.S. Pat. No. 7,718,395 discloses a method for the use of a transparent indicator reagent including a fluorescent substance as a method for determining whether cleaning has been sufficiently performed. This method includes a step of coating the indicator reagent on an object to be cleaned (e.g. table, chair, or the like) prior to cleaning, and a step of determining after cleaning whether or not the indicator reagent is present by sensing light emitted from the fluorescent substance due to irradiation by ultraviolet radiation of the object to be cleaned.

### SUMMARY

### Problems to be Solved by the Invention

For the determination of whether cleaning has been sufficiently performed (i.e. determination of the degree of cleanliness), it is important that the determination is possible by a simple method, that the determination is possible over a wide range, that the determination is highly accurate, and the like.

One object of the present invention is to provide a marker composition for which existence can be sensed over a wide range by a simple method, and a package using the marker composition.

### Means for Solving the Problem

One aspect of the present invention is a marker composition containing retroreflective particles and a dispersion medium, the blending ratio of the retroreflective particles being from 50 to 90 mass % on the basis of the entire amount of the marker composition.

In another aspect of the present invention, the dispersion medium may contain water and a water soluble polymer.

In yet another aspect of the present invention, the water soluble polymer may contain a polymer soluble in both water and an alcohol. Moreover, the aforementioned dispersion medium may further include the alcohol.

In yet another aspect of the present invention, the aforementioned water soluble polymer may include polyvinylpyrrolidone.

In yet another aspect of the present invention, the aforementioned water soluble polymer may include partially crosslinked polyvinylpyrrolidone.

In yet another aspect of the present invention, the aforementioned marker composition may further include a humectant.

In yet another aspect of the present invention, average particle diameter of the aforementioned retroreflective particles may be 10 to 100 μm.

In yet another aspect of the present invention, the dispersion medium may be a dispersion medium soluble in water.

In yet another aspect of the present invention, the pour point of the dispersion medium may be from 0 to 60° C.

In yet another aspect of the present invention, the dispersion medium may contain a nonionic surfactant.

In yet another aspect of the present invention, the dispersion medium may contain a nonionic surfactant and a softener.

In yet another aspect of the present invention, average particle diameter of the aforementioned retroreflective particles may be 10 to 100 μm.

In another aspect of the present invention, a package is provided that is composed of the aforementioned marker composition and a receiver for receiving the marker composition.

In another aspect of the present invention, the receiver may be composed of a receiver part having an indentation part for receiving the marker composition, and an openable lid part for hermetically sealing the indentation part.

With the present invention, it is possible to provide a marker composition for which existence can be sensed with good precision over a wide range by a simple method, and a package using the marker composition.

### BRIEF DESCRIPTION OF THE DRAWINGS

FIG. 1 is a perspective view illustrating an example of a package of the third embodiment.

FIG. 2 is a cross-sectional view of relevant parts of the package shown in FIG. 1.

FIG. 3 is a perspective view illustrating an example of an applicator of the fourth embodiment.

FIG. 4 is a perspective view illustrating another example of the applicator of the fourth embodiment.

FIG. 5 is a perspective view illustrating an example of an applicator set of the fifth embodiment.

FIG. 6 is an exploded view of the applicator set shown in FIG. 5.

FIG. 7 is a perspective view illustrating an example of the applicator set of the sixth embodiment.

FIG. 8 is an image showing the piece of paper to which the marker composition of Working Example 3 had been applied, in a state without irradiation of imaging light.

FIG. 9 is an image showing the piece of paper to which the marker composition of Working Example 3 had been applied, in a state with irradiation of imaging light.

FIG. 10 is an image showing the piece of paper to which the marker composition of Working Example 7 had been applied, in a state without irradiation of imaging light.

FIG. 11 is an image showing the piece of paper to which the marker composition of Working Example 7 had been applied, in a state with irradiation of imaging light.

FIGS. 12a-12d show images of the piece of paper to which the marker composition of Working Example 7 had been applied, showing state without irradiation of imaging light (FIGS. 12a and 12b), and also showing the state with irradiation of imaging light (FIGS. 12c and 12d), where FIGS. 12b and 12d show the paper under magnification.

FIG. 13 is an image showing the piece of paper to which the marker composition of Working Example 8 had been applied, in a state without irradiation of imaging light.

FIG. 14 is an image showing the piece of paper to which the marker composition of Working Example 8 had been applied, in a state with irradiation of imaging light.

FIG. 15 is an image showing the piece of papers to which the marker compositions of Working Examples 12 to 14 had been applied, in a state without irradiation of imaging light.

FIG. 16 is an image showing the piece of papers to which the marker composition of Working Examples 12 to 14 had been applied, in a state with irradiation of imaging light.

FIG. 17 is an image illustrating an applicator produced using the marker composition of Working Example 15 and a piece of paper to which the marker composition of Working Example 15 has been applied, in a state without irradiation of imaging light.

FIG. 18 is an image illustrating an applicator produced using the marker composition of Working Example 15 and a piece of paper to which the marker composition of Working Example 15 has been applied, in a state with irradiation of imaging light.

FIG. 19 is an image illustrating an applicator produced using the marker composition of Working Example 16 and a piece of paper to which the marker composition of Working Example 16 has been applied, in a state without irradiation of imaging light.

FIG. 20 is an image illustrating an applicator produced using the marker composition of Working Example 16 and a piece of paper to which the marker composition of Working Example 16 has been applied, in a state with irradiation of imaging light.

FIG. 21 is an image showing the piece of paper to which the marker composition of Working Example 15 had been applied, in a state without irradiation of imaging light.

FIG. 22 is an image showing the piece of paper to which the marker composition of Working Example 15 had been applied, in a state with irradiation of imaging light.

FIG. 23 is an image illustrating an applicator produced using the marker composition of Working Example 18 and a piece of paper to which the marker composition of Working Example 18 has been applied, in a state without irradiation of imaging light.

FIG. 24 is an image illustrating an applicator produced using the marker composition of Working Example 18 and a piece of paper to which the marker composition of Working Example 18 has been applied, in a state with irradiation of imaging light.

FIG. 25 is an image illustrating an applicator produced using the marker composition of Working Example 19 and a piece of paper to which the marker composition of Working Example 19 has been applied, in a state without irradiation of imaging light.

FIG. 26 is an image illustrating an applicator produced using the marker composition of Working Example 19 and a piece of paper to which the marker composition of Working Example 19 has been applied, in a state with irradiation of imaging light.

FIG. 27 is an image illustrating an applicator produced using the marker composition of Working Example 20 and a piece of paper to which the marker composition of Working Example 20 has been applied, in a state without irradiation of imaging light.

FIG. 28 is an image illustrating an applicator produced using the marker composition of Working Example 20 and a piece of paper to which the marker composition of Working Example 20 has been applied, in a state with irradiation of imaging light.

FIG. 29 is an image showing the piece of papers to which the marker compositions of Working Examples 18 to 20 had been applied, in a state without irradiation of imaging light.

FIG. 30 is an image showing the piece of papers to which the marker composition of Working Examples 18 to 20 had been applied, in a state with irradiation of imaging light.

FIG. 31 is an image showing the piece of paper to which the marker composition of Working Example 20 had been applied, in a state without irradiation of imaging light.

FIG. 32 is an image showing the piece of paper to which the marker composition of Working Example 20 had been applied, in a state with irradiation of imaging light.

FIG. 33 is an image showing the piece of papers to which the marker compositions of Working Examples 21 to 23 had been applied, in a state without irradiation of imaging light.

FIG. 34 is an image showing the piece of papers to which the marker composition of Working Examples 21 to 23 had been applied, in a state with irradiation of imaging light.

FIG. 35 is an image showing the piece of papers to which the marker compositions of Working Examples 24 to 26 had been applied, in a state without irradiation of imaging light.

FIG. 36 is an image showing the piece of papers to which the marker composition of Working Examples 24 to 26 had been applied, in a state with irradiation of imaging light.

FIG. 37 is an image showing the piece of papers to which the marker compositions of Working Examples 27 to 30 had been applied, in a state without irradiation of imaging light.

FIG. 38 is an image showing the piece of papers to which the marker composition of Working Examples 27 to 30 had been applied, in a state with irradiation of imaging light.

FIG. 39 is an image showing the piece of paper to which the marker composition of Working Example 22 had been applied, in a state without irradiation of imaging light.

FIG. 40 is an image showing the piece of paper to which the marker composition of Working Example 22 had been applied, in a state with irradiation of imaging light.

### DETAILED DESCRIPTION

Embodiments of the marker composition, package, applicator, applicator set, degree of cleanliness determination method, and degree of cleanliness determination system of the present invention will be described below in detail.

### First Embodiment: Marker Composition

The marker composition of the first embodiment includes retroreflective particles and a dispersion medium, the dispersion medium including water and a water soluble polymer. In addition, the blending ratio of the retroreflective particles is from 50 to 90 mass % on the basis of the entire amount of the marker composition. Here, the term “retroreflective” refers to the properly of reflecting incident light back in the direction of incidence.

No particular limitation is placed on the retroreflective particles (i.e. beads) as long as the retroreflective particles display retroreflectivity. Examples of substances for use as the retroreflective particles include glass (such as soda-lime glass, borosilicate glass, and barium titanate glass) and high refractive index plastic. Glass may be used with advantage from the standpoint of reflectivity.

From the standpoints of application ability, stability, storage stability, and visibility, average particle diameter of the retroreflective particles may be set to 10 to 100 μm, 20 to 90 μm, or 30 to 80 μm. Dispersability of the retroreflective particles in the dispersion medium may be further increased when the average particle diameter of the retroreflective particles is in the aforementioned range. Moreover, the strength of reflected light from the retroreflective particles may be increased when the average particle diameter of the retroreflective particles is in the aforementioned range. Here, the expression “average particle diameter” means the average particle diameter measured according to JIS K 5600-9-3 (Testing Methods for Paints—Part 9: Coating Powders—Section 3: Particle Size Analysis by Laser Diffraction) or the like.

Particles capable of use as the retroreflective particles are exemplified by “UB-24M” and “UB-35M” (both produced by Unitika Ltd.), Beeko beads, Rambo beads, Tung beads, etc.

From the standpoints of application ability, visibility, and reflectivity, the concentration of the retroreflective particles in the total marker composition may be 75 to 95% by weight, may be 75 to 90% by weight, or may be 75 to 85% by weight. Moreover, when the dispersion medium does not include an alcohol, the concentration of the retroreflective particles in the total marker composition may be 70 to 90% by weight, or may be 75 to 85% by weight.

No particular limitation is placed on the water included in the dispersion medium, and in the present embodiment, deionized water, distilled water, ultra-purified water, or the like may be used with advantage as the water included in the dispersion medium.

From the standpoint of application ability, the water content in the total marker composition is preferably 3 to 25% by weight, further preferably is 4 to 20% by weight, and most preferably is 8 to 14% by weight. If the dispersion medium does not include an alcohol, the water content in the total marker composition is preferably 9.5 to 18% by weight, and further preferably is 15 to 17% by weight.

No particular limitation is placed on the water soluble polymer included in the dispersion medium as long as the water soluble polymer is a polymer that has water solubility. The water soluble polymers include polyvinylpyrrolidone (abbreviated below as PVP); polyvinyl alcohol (abbreviated below as PVA); synthetic polymers such as carboxyvinyl polymer, acrylic acid-methacrylic acid copolymers, and the like; cellulose and cellulose derivatives such as methyl cellulose, hydroxyethyl cellulose, carboxymethyl cellulose, and the like; polysaccharides and polysaccharide derivatives such as starch, guar gum, arginine acid salts, mannan, and the like; polyacrylic acid and derivatives thereof; gums such as xanthan gum, tragacanth gum, guar gum, or the like; hyaluronic acid and derivatives thereof; polyglutamic acid and derivatives thereof; and the like; as well as such polymers that have been physically or chemically partially crosslinked. Furthermore, in the present specification, the water soluble polymer formed by crosslinking of polyvinylpyrrolidone by γ-ray irradiation is referred to as “γ-ray crosslinked polyvinylpyrrolidone” or “X-PVP”.

From the standpoints of application ability and rapid drying ability, the content of the water soluble polymer in the total dispersion medium may be 3 to 20% by weight, 4 to 10% by weight, or 4 to 6% by weight. Moreover, concentration of the water soluble polymer in the total marker composition is preferably 0.8 to 3% by weight, further preferably is 1 to 2.5% by weight, and most preferably is 1.5 to 2.5% by weight. Moreover, when the dispersion medium does not include an alcohol, the concentration of the water soluble polymer in the total marker composition is preferably 0.2 to 4.5% by weight, and further preferably is 0.5 to 2.5% by weight.

The water soluble polymer preferably includes a polymer that is soluble in both water and an alcohol, and the dispersion medium preferably further includes an alcohol. Rapid drying of the marker composition may be further improved by such a water soluble polymer and dispersion medium.

The alcohol is exemplified by isopropyl alcohol (also referred to as “2-propanol”, abbreviated sometimes below as “IPA”), ethanol, methanol, n-propanol, and the like. Moreover, polymers that are soluble in both water and an alcohol are exemplified by polyvinylpyrrolidone, γ-ray crosslinked polyvinylpyrrolidone, polyvinyl alcohol, hydroxymethyl cellulose, hydroxypropylmethyl cellulose phthalate, and the like.

Rapid drying ability of the marker composition may be further improved by including these types of water soluble polymers and alcohols in the dispersion medium.

From the standpoints of application ability and rapid drying ability, the content of the alcohol in the total dispersion medium may be 20 to 60% by weight, 30 to 60% by weight, or 45 to 55% by weight. Moreover, the content of the alcohol in the total marker composition is preferably 4 to 16% by weight, further preferably is 5 to 15% by weight, and most preferably is 6 to 13% by weight.

A preferred aspect of the water soluble polymer is exemplified by polyvinylpyrrolidone or γ-ray crosslinked polyvinylpyrrolidone. By use of such water soluble polymers, it is possible to impart good viscosity to the marker composition, and it is possible to increase adhesiveness and application ability of the marker composition. Thus by use of the marker composition of this aspect, it is possible to obtain further excellent retention ability. For example, it is possible to reliably suppress running and dripping of the marker composition when the marker composition is applied to the surface of a ceiling or wall.

In addition to the retroreflective particles and the dispersion medium, the marker composition of the present embodiment may further include a humectant. It is possible by this means to suppress evaporation of the marker composition, and it is possible to increase storage stability of the marker composition.

The humectant is exemplified by glycerin, propylene glycol, proteins, mucopolysaccharid, collagen, elastin, and the like.

The concentration of the humectant in the total marker composition is preferably 0.1 to 2% by weight, further preferably is 0.5 to 1% by weight, and most preferably is 0.7 to 0.8% by weight. Moreover, if the dispersion medium does not include an alcohol, the concentration of the humectant in the total marker composition is preferably 0.3 to 7.5% by weight, and further preferably is 0.5 to 5% by weight.

In addition to the retroreflective particles and the dispersion medium, the marker composition of the present embodiment may further include a pH adjustment agent. The degree of solubility of the polymer compound included in the dispersion medium may be adjusted by this means, and it is possible to increase application ability of the marker composition.

The pH adjustment agent is exemplified by sodium hydroxide, potassium hydroxide, sodium carbonate, potassium carbonate, and the like.

The marker composition of the present embodiment may further contain other additives (plasticizers, moisturizers, surfactants, preservatives, or the like) within a scope that does not diminish the essence of the present invention.

Viscosity of the non-retroreflective particles ingredient of the marker composition (mixture of ingredients if there are two or more types of such ingredients) at 25° C. may be 2,000 to 100,000 cps, or 4,000 to 80,000 cps, or 6,000 to 60,000 cps. Adhesive strength and application ability of the marker composition may be improved by having viscosity in the aforementioned range. Here, “viscosity” is taken be the viscosity measured in a 25° C. environment based on JISZ 8803 using a B type viscometer (produced by Tokyo Keiki Inc., model BL).

The marker composition of the present embodiment may be obtained by blending of the retroreflective particles, water, the water soluble polymer, and as may be required, an alcohol, and as may be further required, additives such as a humectant and the like. No particular limitation is placed on the order of blending of these components, and for example, all the components may be fed to into a vessel and then blended, or alternatively, after blending of part of the components, the other components may be added and blended in the mixture. The preferred method of preparation is exemplified by a method composed of a step of obtaining the dispersion medium by firstly blending the components included in the dispersion medium, and then a step of obtaining the marker composition by adding and blending the retroreflective particles in the dispersion medium. The processing conditions of each of these steps may be selected appropriately. Furthermore, an additive such as a humectant or the like may be added during preparation of the dispersion medium, or alternatively, the additive may be added to the dispersion medium together with the retroreflective particles, or after addition of the retroreflective particles.

Moreover, an example of the method of preparation of the dispersion medium in a case in which alcohol is used is a method comprising a first step of mixing water and a water soluble polymer in a hermetically sealed vessel for flammable solvents and a second step of adding and mixing alcohol into the mixture obtained in the first step.

According to the marker composition of the present embodiment, it becomes possible to sense the presence or absence of the marker composition over a wide range by a simple method with good accuracy.

That is to say, the aforementioned marker composition is able to stably retain the retroreflective particles in the dispersion medium, and is able to be readily applied over a wide range. Moreover, after application, the marker composition may be readily removed from the application region by wiping using a cleaning article (i.e. cloth, mop, or the like) including water or a mixed liquid of water-alcohol or the like. Furthermore, during application and removal of the marker composition, the marker composition is illuminated by light as natural lighting or indoor lighting. However, since the line of sight of the person holding the cleaning article and cleaning the cleaning region is normally different from the direction of incidence and reflection of light, the person holding the cleaning article and cleaning the cleaning region is normally unable to visually sense reflected light from the retroreflective particles.

Then when light is used to illuminate the aforementioned marker composition, such light is reflected toward the light source irrespective of the position of incidence of light on the particle surface (i.e. irrespective of the incidence angle of light). Thus refection may be detected from a wider range of incident angles in comparison to specular reflection and scattered reflection, and it is possible to increase the intensity of the detected reflected light. Furthermore, the illuminating light may be any type of light that indicates that the retroreflective particles are retroreflective. Thus in comparison to the case of coating the application region with an ultraviolet radiation fluorescing substance and then illuminating the application region with ultraviolet radiation, this method has the advantage of a great degree of freedom in the selection of the type of light with respect to wavelength of the illuminating light, type of light source device, and the like. Moreover, if visible light is selected as the illuminating light, imaging and illumination may be performed, for example, using illumination for imaging (flash lighting) of a normal camera, camera-equipped cellular phone, camera-equipped multifunctional portable phone (smart phone), or the like. Based on the presence or absence of reflected light in the obtained image, it is possible to determine the presence or absence of the marker composition.

Applications of the marker composition of the present embodiment are exemplified by indicators used for determination of degree of cleanliness when cleaning in facilities such as hospitals, hotels, restaurants, and the like. In particular, in hospitals there is danger of cross infection from one patient to another within the hospital due to the hospital being visited by patients infected with various types of diseases. Thus in addition to sufficiently cleaning the interior of the hospital, it is important to determine with good accuracy whether the cleaning inside the hospital has been sufficiently performed. The marker composition of the present embodiment in such an application is extremely useful due to the ability to sense the degree of cleanliness with good accuracy by a simple method that detects the presence or absence of the marker composition in a wide range.

### Second Embodiment: Marker Composition

The marker composition of the second embodiment contains retroreflective particles and a dispersion medium soluble in water.

The same particles as the retroreflective particles of the first embodiment can be used as the retroreflective particles of the second embodiment. Here, duplicate explanations will be omitted.

From the perspectives of applicability, visibility, and reflectivity, the content ratio of the retroreflective particles in the marker composition of the second embodiment is preferably from 60 to 80 mass %, more preferably from 70 to 80 mass %, and even more preferably from 75 to 80 mass % on the basis of the entire mass of the marker composition. In addition, when the content ratio of the retroreflective particles is within the range described above, the marker composition can be wiped away more easily, and the marker composition can be used over a wider temperature range.

The dispersion medium is not particularly limited as long as the dispersion medium is soluble in water. The dispersion medium may be in a wax form or a paste form at room temperature (25° C.). Here, a “wax form” means that the medium is in a solid form or a wax form at room temperature. In addition, a “paste form” means that the medium is in a state that does not flow unless a prescribed external force (yield stress) is applied at room temperature (Bingham fluid form).

The pour point of the dispersion mediums preferably from 0 to 60° C., more preferably from 10 to 55° C., and even more preferably from 20 to 40° C. When the pour point is within the range described above, the viscosity, adhesive strength, and applicability of the marker composition can be further improved. Here, the “pour point” refers to the pour point measured in accordance with JIS K 2269.

The mass ratio of the retroreflective particles and the dispersion medium can be set to 90:10 to 50:50, 85:15 to 55:45, or 80:20 to 60:40.

The dispersion medium preferably contains a nonionic surfactant. As a result, the marker composition can be wiped away more easily using a moist cloth or the like. The nonionic surfactant is not particularly limited as long as it is in a gel form or a paste form. For example, a polyethylene glycol type or polyvalent alcohol type nonionic surfactant can be used as such a nonionic surfactant. When the dispersion medium does not contain a softener, the pour point of the nonionic surfactant is preferably from 0 to 60° C., more preferably from 10 to 55° C., and even more preferably from 20 to 40° C.

In addition, the dispersion medium may contain a nonionic surfactant and a softener. As a result, the viscosity, adhesive strength, and applicability of the marker composition can be further improved. In this case, the pour point of the dispersion medium can be adjusted more easily by appropriately setting the type and content ratio of the softener in accordance with the type and content ratio of the nonionic surfactant. Therefore, the degree of freedom expands with regard to the selection of the type and content of the nonionic surfactant used in the dispersion medium. For example, by adding a softener to a nonionic surfactant having a pour point exceeding 60° C., the pour point of the entire dispersion medium can be preferably set to 0 to 60° C., more preferably from 10 to 55° C., and even more preferably from 20 to 40° C. In addition, in this aspect as well, it is possible to use a nonionic surfactant having a pour point of preferably from 0 to 60° C., more preferably from 10 to 55° C., and even more preferably from 20 to 40° C.

Examples of nonionic surfactants include polyoxyethylenes, polyols, siloxanes, polyoxyethylene oleyl ethers, polyoxyethylene lauryl ethers, polyoxyethylene isocetyl ethers, polyoxyethylene-polyoxypropylene block copolymers (trade names Pluronic, Tween, Poloxamer, and Span). One type of these may be used alone, or two or more types may be used in combination.

The content ratio of the nonionic surfactant is preferably from 30 to 100 mass %, more preferably from 45 to 100 mass %, and even more preferably from 60 to 100 mass % on the basis of the entire mass of the dispersion medium.

The softener is not particularly limited as long as it softens the dispersion medium, but a water-soluble substance in the form of a liquid at 4 to 60° C., for example, may be used.

Examples of softeners include glycerin, polyethylene glycol, polypropylene glycol, sorbitan sesquioleate, sorbitan sesquiisostearate, sorbitan oleate, sorbitan isostearate, sorbitan cocoate, polysorbate 80, lauryl alcohol, oleyl alcohol, phenol ethoxylate, polyethylene glycol oleate, polyoxyalkylene ether toloate, capryl glycol, diglycerin lauryl esters, diglycerin oleyl esters, hexaglycerin capryl esters, and decaglycerin lauryl esters.

The content ratio of the softener is preferably from 3 to 50 mass %, more preferably from 20 to 40 mass %, and even more preferably from 25 to 35 mass % on the basis of the entire mass of the dispersion medium.

The marker composition of the present embodiment can be used in a non-aqueous state essentially containing no water except naturally absorbed moisture. The water content due to natural moisture absorption is preferably at most 10 mass %, more preferably at most 5 mass %, and even more preferably at most 3 mass %.

The marker composition of the present embodiment may further contain other additives (plasticizers, moisturizers, surfactants, preservatives, or the like) within a scope that does not diminish the essence of the present invention.

The marker composition of the present embodiment may be obtained by mixing the retroreflective particles, the dispersion medium soluble in water, and as may be required, additives such as a softener. No particular limitation is placed on the order of blending of these components, and for example, all the components may be fed to into a vessel and then blended, or alternatively, after blending of part of the components, the other components may be added and blended in the mixture. The preferred method of preparation is exemplified by a method composed of a step of obtaining the dispersion medium by firstly blending the components included in the dispersion medium, and then a step of obtaining the marker composition by adding and blending the retroreflective particles in the dispersion medium. The processing conditions of each of these steps may be selected appropriately. Furthermore, additives such as a softener may be added at the time of the preparation of the dispersion medium or may be added to the dispersion medium together with the retroreflective particles or after the addition of the retroreflective particles.

### Third Embodiment: Package

The package of the third embodiment comprises the marker composition and a receiver for receiving the marker composition. According to this aspect, the marker composition may be readily carried about. The marker composition of the first embodiment or the second embodiment may be used as the marker composition in the third embodiment.

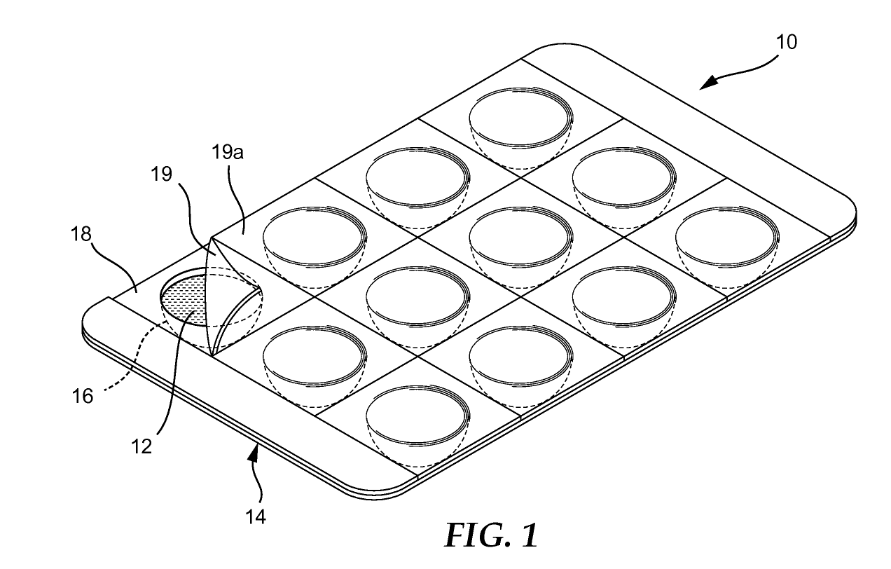

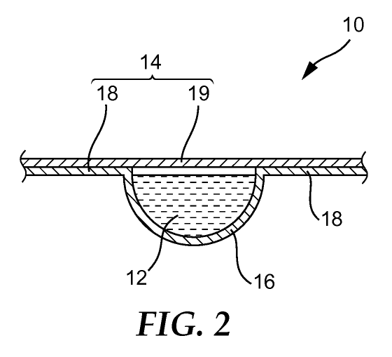

FIG. 1 is a tilted perspective view showing an example of the package of the present embodiment. Moreover, FIG. 2 is a cross-sectional view of the relevant parts of the package shown in FIG. 1.

The package 10 is composed of the marker composition 12, a receiver 14 for receiving the marker composition 12, and a lid part 19.

In the receiver 14, multiple receiver parts 18 are formed that have indentation parts 16, and the marker composition 12 is received in each of the indentation parts 16. The multiple receiver parts 18 are linked so as to be capable of being separated from one another. By covering the opening part of the indentation part 16, the lid part 19 hermetically seals the receiver parts 18 and is attached to the receiver 14 so as to be capable of opening the receiver parts 18 by peeling off or breakage of the lid part 19. Rupture parts 19a are arranged in this lid part 19 at positions corresponding to the linking parts of the adjacent receiver parts 18. The sizes and shapes of the indentation parts 16 may be selected appropriately according to the shape of the applicator body used in combination with the indentation parts 16. For example, if a commercially marketed cotton swab is used as the applicator body, diameter of the opening part may be set to 5 to 30 mm, and depth may be set to 2 to 10 mm.

In the state in which the lid part 19 is attached to the receiver 14, the lid part 19 hermetically seals the receiver part 18, the marker composition 12 is shielded from external air, and it is thus possible to increase storage stability of the marker composition 12. Furthermore, the marker composition 12 becomes readily carried about by carrying about of the package 10 in this state, and it is possible to prevent leakage of the marker composition 12 from the receiver 14, and to prevent attachment of the marker composition 12 to skin, clothing, or the like. The lid part 19, for example, may be a heat sealable film.

The marker composition 12 may be applied by peeling away or breaking the lid part 19 to open the receiver part 18, and then taking the marker composition 12 out of the package 10. Peeling off or breakage of the lid part 19 may be performed for individual receiver parts 18, or peeling off or breakage may be performed for a part of the lid part 19 corresponding to multiple receiver parts 18.

Moreover, a unit that integrates part of the receiver part 18 and part of the lid part 19 corresponding to the part of the receiver part 18 may be used by separation from the package 10.

The method of production of the package 10, for example, feeds the marker composition 12 from fill nozzles connected to a pump so that the marker composition 12 is fed to the indentation parts 16 in the opened state, and thereafter attaches the lid part 19 to the receiver 14 so as to cover the opening parts of the indentation parts 16 and hermetically seal the receiver parts 18. The processing conditions during feeding of the marker composition 12 to the receiver part 18 (i.e. feed rate, process temperature, or the like of the marker composition 12) may be selected appropriately according to the physical properties of the marker composition 12 (e.g. viscosity, fluid flow properties, or the like) and the shape, volume, or the like of the receiver part 18.

The package according to the present embodiment is not limited to the aforementioned aspect, and various variations are possible. For example, the package may have a single receiver part or multiple receiver parts. If the package has multiple receiver parts, the number of receiver parts per single package, may be 2 to 30, for example.

Moreover, if the package has multiple receiver parts, there is no particular limitation placed on the shape of the linking parts between adjacent receiver parts and the rupture parts of the lid part, and these parts may have a linear shape, curved shape, serrated shape, or the like.

Moreover, no particular limitation is placed on the shape of the receiver parts provided in the package, as long as this shape allows receiving of the marker composition. No particular limitation is placed on the shape of the opening of the indentation part, and this shape may be circular, elliptical, or polygonal (e.g. triangular, square, or the like). Furthermore, stylishness may be imparted by providing a star-shaped opening.

### Fourth Embodiment: Applicator

The applicator of the fourth embodiment is provided with the marker composition and an applicator capable of retaining the marker composition. The marker composition may be readily applied by this means. Here, “retention” includes housing or storing the marker composition inside the applicator body. In addition, the marker composition of the first embodiment or the second embodiment may be used as the marker composition in the fourth embodiment.

The aforementioned applicator body may be porous. By this means, the retention ability of the marker composition by the applicator body becomes good, and it is possible to further improve the ability to apply the marker composition.

The aforementioned applicator body may have interconnected cells within the applicator body. The marker composition within the applicator body may be readily transferred by this means, and thus the marker composition becomes retained in a more uniform manner by the applicator body. It is thus possible for this applicator to more uniformly apply the marker composition.

The cell count of the aforementioned interconnected cells is preferably 15 to 100 per 25 mm, further preferably is 25 to 70 per 25 mm, and most preferably is 35 to 45 per 25 mm. As a result, the transferability (ease of filling the applicator body with the marker composition, ease of applying the marker composition, or the like) of the marker composition and the retention ability of the marker composition in the applicator body can be improved with good balance. Thus the applicator of this aspect is capable of application of the marker composition with greater uniformity even when the applicator is repeatedly used. In the present specification, the term “cell count” indicates the number of cells per 25 mm.

The aforementioned applicator may be further composed of a retention body for retaining the aforementioned applicator body so that at least part of the aforementioned applicator body is exposed, and a lid body, detachably attached to the aforementioned retention body, for hermetic sealing of the exposed part of the aforementioned applicator body. Long-term storage of the marker composition becomes possible by this means.

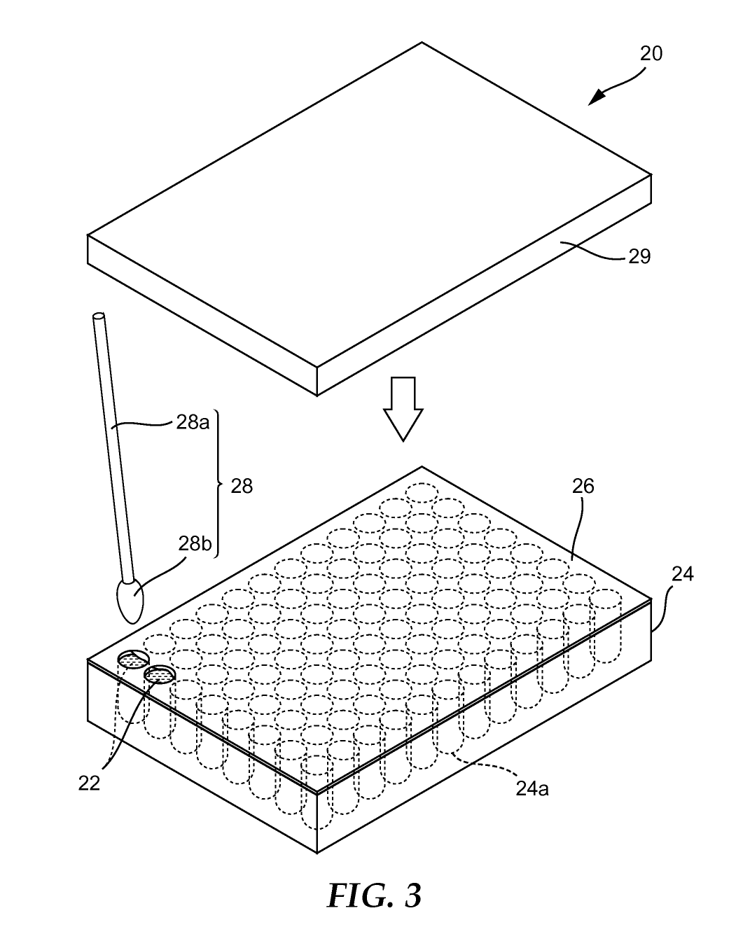

FIG. 3 is a tilted perspective view showing an example of the applicator of the present embodiment. The applicator 20 is composed of the marker composition 22, a receiver 24 for receiving the marker composition 22, a lid body 26 for covering the receiver 24, an applicator body 28 capable of retaining the marker composition 22, and a protection body 29 for protecting the exposed face side of the lid body 26.

Multiple concave-shaped receiver parts 24a are formed in the receiver 24 for receiving the marker composition 22. The marker composition 22 is received in each of the receiver parts 24a. A lid body 26 for covering the opening side of the receiver part 24a is attached to the receiver 24. The receiver part 24a is hermetically sealed by this lid body 26. The shape and size of the receiver part 24a may be selected appropriately according to the shape of the applicator body 28. For example, if a commercial cotton swab is used as the applicator body 28, the diameter of the opening part may be set to 3 to 20 mm, and the depth may be set to 3 to 20 mm. The receiver 24, for example, may be a commercial microplate. Furthermore, the number of receiver parts 24a of the receiver 24 may be a single receiver part 24a.

The applicator body 28 has a support part 28a, and an application part 28b capable of retaining the marker composition 22 at the distal tip of the support part 28a. The applicator body 28 may be a commercial cotton swab, for example.

Although the lid body 26 hermetically seals the receiver part 24a, the lid body 26 is capable of being readily broken by a method such as being pressed by the application part 28b of the applicator body 28. The marker composition 22 within the receiver part 24a may be readily attached to the application part 28b of the applicator body 28. Although the lid body 26 may be readily broken in this manner, due to protection of the lid body 26 by the protection body 29, it is possible to safely carry about the applicator 20. The lid body 26 is a heat sealed film, for example.

The applicator 20 may be manufactured, for example, by a method such as feeding the marker composition 22 from a fill nozzle connected to a pump into the receiver part 24a in the open state, and thereafter attaching the lid body 26 to the receiver 24 so as to cover the opening part of the receiver part 24a. The process conditions (e.g. feed rate, processing temperature, or the like of the marker composition 22) during feeding of the marker composition 22 to the receiver part 24a may be selected appropriately according to the physical properties of the marker composition 22 (e.g. viscosity, fluid flow properties, or the like) and the shape, volume, or the like of the receiver 24.

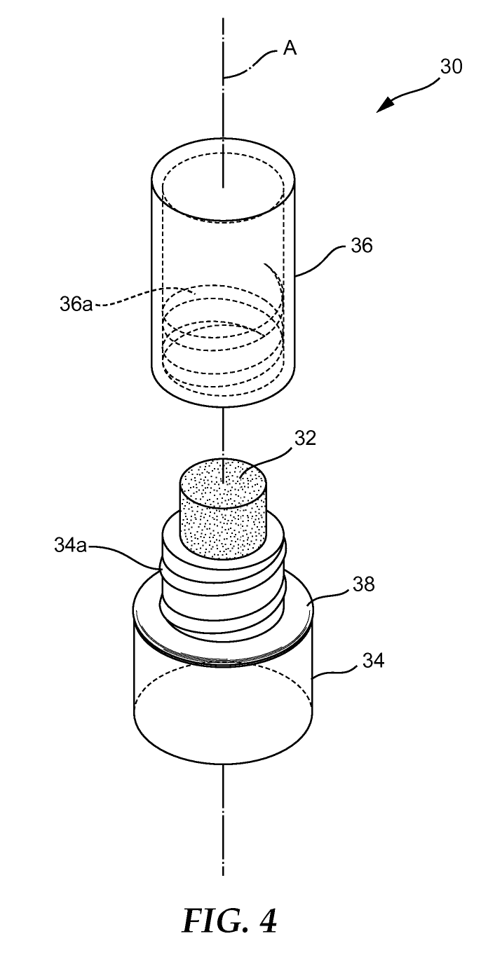

FIG. 4 is a tilted perspective view showing another example of the applicator of the present embodiment. The applicator 30 is composed of an applicator body 32 capable of retaining the marker composition, a retention body 34 for retaining the applicator body 32, a lid body 36 (detachably attached to the retention body 34) for hermetically sealing the applicator body 32, and a sealing component 38 (mounted on the retention body 34) for sealing the gap between the retention body 34 and the lid body 36. The applicator body 32 is constructed from a porous material, and the marker composition is retained within the applicator body 32. That is, in the applicator 30 illustrated in FIG. 4, the applicator body 32 provides a function as a retention body for housing or storing the marker composition inside in addition to the original function as the applicator body of the marker composition.

A porous substance (e.g. sponge) may be used as the applicator body 32. The applicator body 32 preferably has interconnected cells within the interior of the applicator body 32, and the cell count of such interconnected cells is preferably 30 to 100 per 25 mm.

No particular limitation is placed on the substances of the retention body 34 and the lid body 36, and this substance may be metal, plastic, glass, or the like. Moreover, the retention body 34 and lid body 36 may be transparent or colored.

An O-ring may be used as the sealing component 38, for example. No particular limitation is placed on the substance of the sealing component 38, and this substance may be rubber or the like. Moreover, the sealing component 38 may be transparent or colored.

A male thread part 34a is arranged at the applicator body 32 side of the side part exterior wall face of the retention body 34, and a female thread part 36 is arranged in the region of the opening side of the inner wall face of the lid body 36. According to this aspect, the hermetic sealing of the applicator body 32 and the attachment of the lid body 36 to the retention body 34 are possible by screwing together of the male thread part 34a and the female thread part 36a, and storage stability of the marker composition may be increased. Moreover, the retention body 34 is shaped such that, when the retention body 34 is sliced by a vertical plane along the A axis in FIG. 4, cross-sectional area of the part where the male thread part 34a is arranged becomes smaller than the cross-sectional area of the part where the male thread part 34a is not arranged. The sealing component 38 has a ring shape, and the outer wall face of the inside of the sealing component 38 is capable of fitting the outside wall face of the part of the retention body 34 where the male thread part 34a is arranged. The sealing component 38 is mounted by fitting the side part outer wall face of the part of the retention body 34 where the male thread part 34a is arranged, so as to contact the interface between the part of the retention body 34 where the male thread part 34a is arranged and the part where the male thread part 34a is not arranged. When the lid body 36 is mounted on the retention body 34, the sealing component 38 is sandwiched between the lid body 36 and the aforementioned interface of the retention body 34, and the gap between the retention body 34 and the lid body 36 is sealed. It is thus possible to increase air tightness of the space for hermetic sealing of the applicator body 32. Thus according to this aspect, degradation, evaporation, or the like of the marker composition can be effectively suppressed, and it is possible to further increase storage stability of the marker composition. Moreover, by carrying the applicator about in this condition, the marker composition becomes readily transported, and it is possible to prevent leakage of the marker composition from the applicator body 32 and to prevent attachment of the marker composition to the skin, clothing, or the like.

Moreover, during application of the marker composition, by unscrewing apart of the male thread part 34a and the female thread part 36a, the lid body 36 becomes separated from the retention body 34, and it is possible to open the applicator body 32.

Moreover, the means for attaching the lid body to the retention body of the applicator shown in FIG. 4, may use any shape capable of joining together the retention body and the lid body, such as a shape in which the outer wall face of the retention body and the inner wall face of the lid body each have roughly the same cross-sectional shape (when viewed in cross-section cut vertically along the A axis in FIG. 4), or the like. Moreover, a protruding part capable of fitting the inner wall face of the lid body may also be arranged in the outer wall face of the retention body, or the like, to form a shape capable of latching the lid body to the retention body. By using the sealing component to seal the gap between the retention body and the lid body also for these attachment means, it is possible to further increase air tightness of the space for hermetic sealing of the applicator body.

When the applicator 30 is used for applying the marker composition, for example, the side part of the retention body 34 is grasped, and the exposed part of the applicator body 32 is pressed against the surface of the application target, or alternatively, the applicator 30 is rotated while in contact with the application target, so that the marker composition may be attached or transferred to the surface of the application target. This type of application uses the applicator 30 as a stamp-type applicator. According to this method, in the surface of the application target, a single or multiple application regions may be formed corresponding to the shape of the part of the applicator target contacting the surface of the applicator body 32.

Moreover, the exposed part of the applicator body 32 may perform application of the marker composition by being moved along the surface of the application target while being pressed against the surface of the application target. According to this method, it is possible to form a strip-shaped application region on the face of the application target, and it is possible to use the marker composition to fully coat a certain region on the face of the application target.

Shape and size of the applicator 30 may be selected appropriately in consideration of ready portability, ease of grasping during application, ease of attachment of the lid body 36 to the retention body 34, ease of detachment of the lid body 36 from the retention body 34, and the like. For example, total length of the applicator 30 along the A axis in FIG. 4 may be set to 10 to 50 mm, and the diameter of the cross-section obtained by slicing the applicator 30 along a perpendicular plane at the A axis in FIG. 4 may be set to 5 to 30 mm.

The method for production of the applicator 30 is composed of a step of using the marker composition to fill the applicator body 32, a step of attaching the applicator body 32 filled by the marker composition to the retention body 34, and a step of attaching the lid body 36 to the retention body 34, for example.

Moreover, the method of using the marker composition to fill the applicator body 32 may feed the marker composition to the applicator body 32 through a fill nozzle connected to a pump, for example. The processing conditions of this method (e.g. marker composition feed rate, marker composition pressure, processing temperature, or the like) may be selected appropriately according to physical properties of the marker composition (e.g. viscosity, fluid flow properties, or the like), physical properties of the applicator body 32 (e.g. size and cell count of the interconnected cells, or the like), or the like. During filling, as may be required, heated marker composition may be fed to the applicator body 32. Moreover, if the marker composition is fed to the applicator body 32 while the applicator body 32 is shaken, it is possible to readily fill the applicator body 32 with the marker composition and to spread the marker composition in the interior part of the applicator body 32. Furthermore, the surface of the applicator body 32 filled by the marker composition may undergo grinding processing.

The applicator of the present embodiment is not limited to the aforementioned aspect, and various modifications are possible. For example, the receiver part of the applicator shown in FIG. 3 may be a single receiver part or multiple receiver parts. When the applicator has multiple receiver parts, the number of receiver parts per single applicator may be 2 to 20, for example.

Moreover, the means for hermetic sealing of the applicator body in the applicator shown in FIG. 4 may use a shape capable of joining together the retention body and lid body using a lid body inner wall face and retention body outer wall face each having roughly the same cross-sectional shape when sliced vertically at the A axis in FIG. 4, or the like. Moreover, the applicator may have a screw-type fastener to make possible detachable attachment of the lid body to the retention body. Furthermore, by use of a sealing component to seal the gap between the retention body and the lid body, it is possible to increase air tightness of the space for hermetic sealing of the applicator body. Moreover, due to greatly increased storage stability of the marker composition during storage of the applicator, storage is permissible by inserting the applicator in a highly hermetically sealed container (e.g. bag, housing, or the like).

When the applicator body of the applicator does not have a function as a retainer for housing or storing the marker composition on the inside, the marker composition can be applied by supplying the marker composition to the applicator body from the vessel (reservoir) housing or storing the marker composition. However, when the marker composition is applied to a plurality of hospital rooms in a hospital using such an applicator, for example, it is necessary to be sufficiently cautious so that there is no contamination of the marker composition inside the applicator body or the reservoir at the time of use or spread of pathogens due to the use of the contaminated applicator at other locations. In addition, when the reservoir is damaged as a result of the applicator being accidentally dropped on the floor, for example, the contaminated marker composition may scatter and cause pathogens to be diffused over a wide area, so sufficient caution is required when handling the applicator. This has the advantage that when the applicator illustrated in FIG. 4 is used, a plurality of applicators are prepared in advance, and the applicator body of an applicator used in a given hospital room is sealed with a lid after use or is stored in the hospital room or discarded after use, while the application of the marker composition in other hospital rooms is achieved using other applicators, which makes it possible to prevent the spread of pathogens due to contaminated applicators. Furthermore, in the applicator illustrated in FIG. 4, the marker composition is retained inside the applicator body. Therefore, even if the applicator is accidentally dropped on the floor or the like, it is unlikely that the marker composition will scatter, which is useful from the perspective of preventing the spread of pathogens.

### Fifth Embodiment: Applicator Set

The applicator set of the fifth embodiment includes the marker composition and multiple applicators having an applicator body capable of retaining the marker composition. The applicator has a retention body for retaining the respective applicator bodies. The retention body includes a retention part for retaining the applicator body so that at least part of the applicator body is exposed, and a lid part capable of detachably attaching to the retention parts of other applicators, and capable of hermetically sealing the exposed part of the applicator body of the other applicators. The marker composition of the first embodiment or the second embodiment may be used as the marker composition in the fifth embodiment.

One of the applicators among the aforementioned multiple applicators may be capable of being distinguished from the other applicators. In this case, it is possible to readily determine whether all the applicators provided by the applicator set have been used (i.e. determination of the time to end use of the applicator set). Moreover, each of the multiple applicators may be capable of being distinguished from the other applicators. In this case, it becomes easy to use different applicators of the multiple applicators according to differing locations, usages, or the like. Although no particular limitation is placed on the means for distinguishing between the applicators, such means are exemplified by use of a color, material, shape (e.g. concavity), or the like on at least part of the applicator so as to differ from the other applicators, and the application of markers to the applicators.

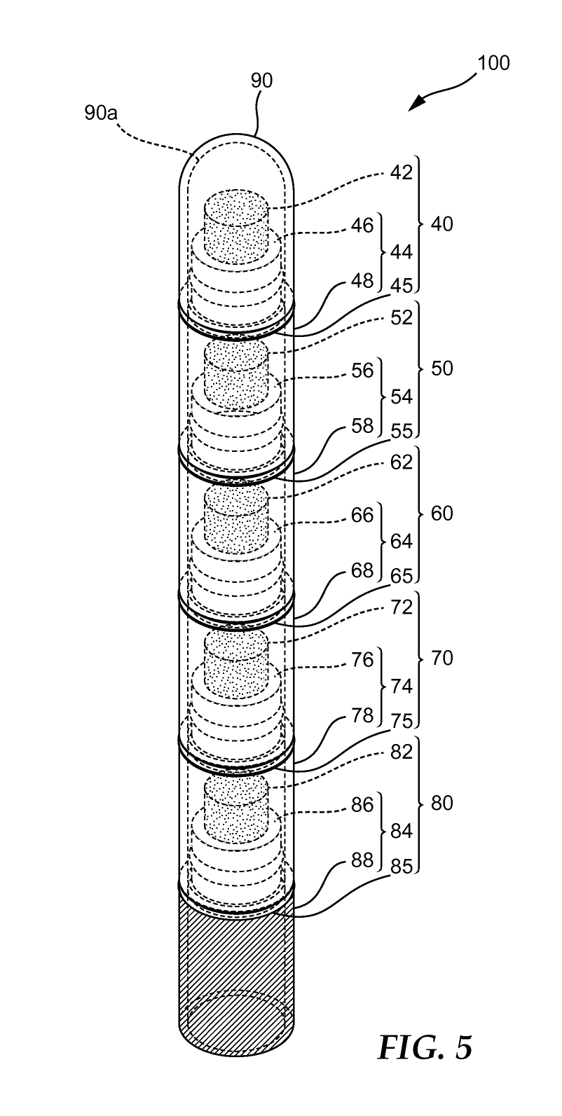

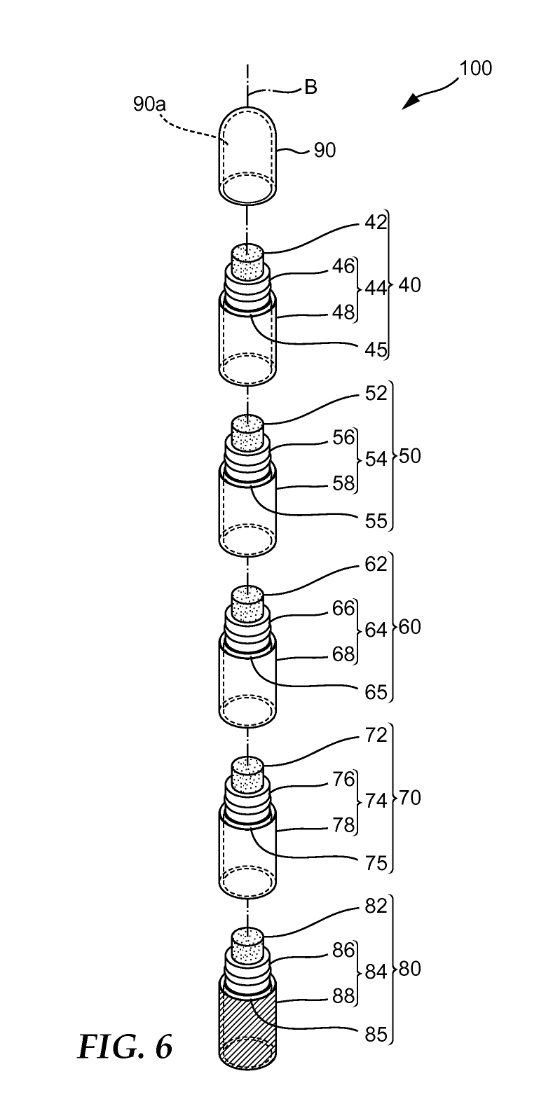

FIG. 5 is a tilted perspective view showing an example of the applicator set of the present embodiment. Moreover, FIG. 6 is an exploded view of the applicator set shown in FIG. 5. The applicator set 100 is composed of applicators 40, 50, 60, 70, and 80, and lid body 90. Hereafter, the applicators 40 and 50 and the lid body 90 will be used as examples to explain the relationships of adjacent elements in detail, but the configurations and shapes of the applicators 40, 50, 60, 70, and 80 (when a means capable of distinguishing between applicators as described above is applied, these are the configurations and shapes of parts other than this means) may be the same as one another.

The applicator 40 is composed of an applicator body 42, a retention body 44 for retention of the applicator body 42, and a sealing component 45 attached to the retention body 44 for sealing the gap between the retention body 44 and the lid body 90. A retention part 46 at the side near the applicator body 42, and a lid part 48 at the side far from the applicator body 42, are arranged in the retention body 44. The retention part 46 has a shape such that cross-sectional area of the tip part distant from the applicator body 42 becomes larger than cross-sectional area of the tip part near the applicator body 42 when the retention body 44 is sliced at a certain position along a vertical plane at the B axis in the FIG. 6, and the retention part 46 has a shape so as to fit and to well hermetically seal the opening part of the lid body 90. The sealing component 45 has a ring shape, and the exterior wall face of the interior of the sealing component 45 is capable of fitting the side part exterior wall face of the retention part 46. The sealing component 45 is made capable of contacting the interface between the retention part 46 and the lid part 48, and it is attached by fitting together with the side part exterior wall face of the retention part 46. When the lid body 90 is fit onto the retention part 46, the sealing component 45 is sandwiched between the lid body 90 and the aforementioned interface surface of the retention body 44, and the gap between the retention body 44 and the lid body 90 is sealed so that it is possible to increase air tightness of the space for hermetically sealing the applicator body 42. Moreover, the opening part of the lid part 48 has a shape capable of fitting well and hermetically sealing with the adjacent applicator 50 and the retention part 56 thereof. When the lid part 48 fits together with the retention part 56, the sealing component 55 of the applicator 50 seals the gap between the retention body 54 and the lid part 58, so that air tightness of the space for hermetic sealing of the applicator body 52 may be increased. By this means, the applicator 40 and the lid body 90 may be connected in a detachably attached manner with good hermetic sealing, the applicator 40 and the applicator 50 may be connected in a detachably attached manner with good hermetic sealing, and it is possible to increase storage stability of the marker composition. Moreover, by carrying about the applicator in this state, the marker composition may be readily transported, it is possible to prevent leakage of the marker composition from the applicator bodies 42 and 52, and it is possible to prevent attachment of the marker composition to the skin, clothing, or the like.

Moreover, by separation of the applicator 40 from the lid body 90 during application of the marker composition, it is possible to open the applicator body 42, and it is possible to apply the marker composition retained in the applicator body 42.

For example, by grasping the side part of the applicator set 100 in the state in which the applicators 40, 50, 60, 70, and 80 are joined together, simply by pressing the exposed part of the applicator body 42 of the applicator 40 at the distal tip position against the surface of the application target, it is possible to attach or transfer the marker composition to the surface of the application target. This application method uses the applicator set 100 as a stamp type applicator, and according to this method, it is possible to form one or multiple application regions corresponding to the shape of the part of the applicator body 42 contacting the surface of the application target.

Moreover, the marker composition may be applied by movement of the exposed part of the applicator body 42 along the surface of the application target in a state in which the exposed part is pressed against the application target. According to this method, it is possible to form a strip-shaped application region on the face of the application target, and it is possible to use the marker composition to fully coat a certain region on the face of the application target.

Furthermore, after application of the marker composition, the spent applicator 40 may be separated from the adjacent applicator 50, and the spent applicator 40 may be joined to the applicator 80 positioned at the other tip of the applicator set 100, so as to open the applicator body 52 at the applicator 50. By then pressing the exposed part of the applicator body 52 against the surface of the application target, it is possible to apply the marker composition retained by the applicator body 52. This method uses the applicator set 100 as a multi-stamp type applicator. For example, during use within the medical ward of a hospital, even if a pathogen becomes attached to the applicator body 42 of the applicator 40, the applicator body 42 is hermetically sealed by the lid part 88 of the applicator 80, and it is thus possible to prevent the spread of the pathogen to other hospital wards. In addition, the spread of pathogens due to a contaminated applicator can also be prevented by storing or discarding the applicator 40 used in a given hospital room in the room after use and applying the marker composition in other hospital rooms using the applicator set 100 from which the applicator 40 has been separated.

Shape and size of the applicator set 100 may be selected appropriately in consideration of factors such as ease of transport, ease of grasping during application, ease of attachment-detachment of the applicators 40, 50, 60, 70, and 80 and the lid body 90, or the like. For example, diameter of the cross section obtained by cutting the applicator set 100 along a vertical plane including the B axis in FIG. 6 may be set to 5 to 20 mm, and the overall length of the applicator set along the B axis in FIG. 6 may be set to 10 to 50 mm.

Moreover, no particular limitation is placed on the material of the retention body 44, 54, 64, 74, 84, and the lid body 90, and this material may be a metal, plastic, glass, or the like. Moreover, the retention body 44, 54, 64, 74, 84, and the lid body 90 may be transparent or colored.

An O-ring may be used as the sealing component 45, 55, 65, 75, and 85, for example. No particular limitation is placed on the substance of the sealing components 45, 55, 65, 75, and 85, and this substance may be transparent or colored.

The method of production of the applicator set 100 is exemplified by a method composed of: a step of using the marker composition to fill each of the applicator bodies 42, 52, 62, 72, and 82; a step of attaching the applicator bodies 42, 52, 62, 72, and 82 filled by the marker composition to the retention bodies 44, 54, 64, 74, and 84, respectively, to obtain the applicators 40, 50, 60, 70, and 80, respectively; and a step of joining together the applicators 40, 50, 60, 70, and 80, and the lid body 90.

Moreover, the method of using the marker composition to fill the applicator bodies 42, 52, 62, 72, and 82 is exemplified by the method of feeding the marker composition to the applicator bodies 42, 52, 62, 72, and 82 through a fill nozzle connected to a pump. The processing conditions of this method (e.g. marker composition feed rate, marker composition pressure, processing temperature, or the like) may be selected appropriately according to physical properties of the marker composition (e.g. viscosity, fluid flow properties, or the like), physical properties of the applicator body 32 (e.g. size and cell count of the interconnected cells, or the like), or the like. During filling, as may be required, heated marker composition may be fed to the applicator bodies 42, 52, 62, 72, and 82. Moreover, if the marker composition is fed to the applicator bodies 42, 52, 62, 72, and 82 while the applicator bodies 42, 52, 62, 72, and 82 are shaken, it is possible to readily fill the applicator bodies 42, 52, 62, 72, and 82 with the marker composition and to spread the marker composition in the interior part of the applicator bodies 42, 52, 62, 72, and 82. Furthermore, the surface of the applicator bodies 42, 52, 62, 72, and 82 filled by the marker composition may undergo grinding processing.

The applicator set of the present embodiment is not limited to the aforementioned aspect, and various types of variations are possible. For example, the means of connection between separate applicators and the means of connection between the applicator and the lid body, in the same manner as the applicator of the forth embodiment, may arrange a male thread part at the retention part of the applicator, arrange a female thread part at the lid body and lid part of the applicator, and may perform attachment by screwing together these threaded members. Moreover, the lid part may be shaped so as to be capable of latching with the retention part, for example, by providing the exterior wall face of the retention part with a protuberance part capable of latching with the inner wall face of the lid part. It is possible by such joining means to use the sealing component to seal the gap between the retention part and the lid part and to increase air tightness of the space for hermetically sealing the applicator body. Moreover, the applicator and lid body may each have a fastener to make the applicator and lid body capable of mutual detachable attachment. Furthermore, the applicator set may be inserted and stored in a highly hermetically sealed container (e.g. bag, housing, or the like) in order to further increase storage stability of the marker composition during storage of the applicator set.

In addition, no particular limitation is placed on the number of applicators of the applicator set, and a single applicator set may have from 1 to 20 applicators.

### Sixth Embodiment: Applicator Set

The applicator set of the sixth embodiment is provided with the marker composition and a plurality of applicators having applicator bodies capable of retaining the marker composition. Each applicator is further equipped with a retention body for retaining the applicator body so that at least part of the applicator body is exposed, and a lid body which is detachably attached to the retention body so as to hermetically seal the exposed portion of the applicator body. In addition, the applicator set described above is further equipped with a fixing member for integrally fixing a plurality of applicators. The marker composition of the first embodiment or the second embodiment may be used as the marker composition in the sixth embodiment.

One of the applicators among the aforementioned multiple applicators may be capable of being distinguished from the other applicators. In this case, it is possible to readily determine whether all the applicators provided by the applicator set have been used (i.e. determination of the time to end use of the applicator set). Moreover, each of the multiple applicators may be capable of being distinguished from the other applicators. In this case, it becomes easy to use different applicators of the multiple applicators according to differing locations, usages, or the like. Here, although no particular limitation is placed on the means for distinguishing between the applicators, such means are exemplified by use of a color, material, shape (e.g. concavity), or the like on at least part of the applicator so as to differ from the other applicators, the application of markers to the applicators, the application of markers to the fixing member, and the like.

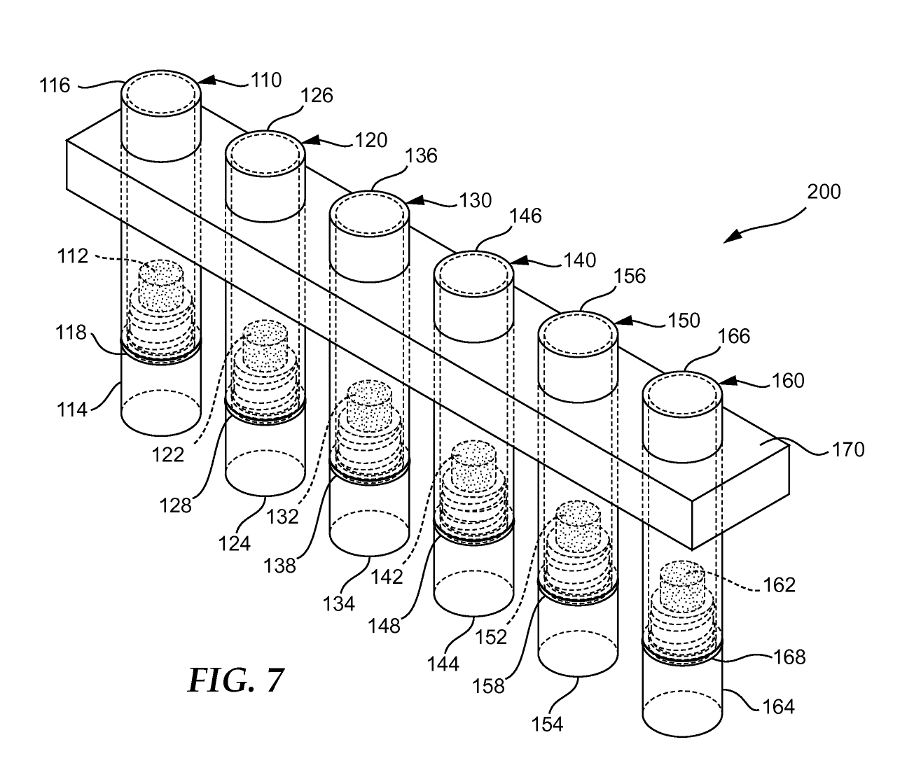

FIG. 7 is a tilted perspective view showing an example of the applicator set of the present embodiment. The applicator set 200 is equipped with applicators 110, 120, 130, 140, 150, and 160 and a fixing member 170. Hereafter, the relationship between the applicator 110 and the fixing member 170 will be explained as an example, but the relationships between the applicators 120, 130, 140, 150, and 160 and the fixing member 170 are also the same as the relationship between the applicator 110 and the fixing member 170. In addition, the configurations and shapes of the applicators 110, 120, 130, 140, 150, and 160 (when a means capable of distinguishing between applicators as described above is applied, these are the configurations and shapes of parts other than this means) may be the same as one another. For example, the respective applicators 110, 120, 130, 140, 150, and 160 may have the same configurations and shapes as the applicators illustrated in FIG. 4.

The applicator 110 is composed of an applicator body 112 capable of retaining the marker composition, a retention body 114 for retaining the applicator body 112, a lid body 116 (detachably attached to the retention body 114) for hermetically sealing the applicator body 112, and a sealing component 118 (mounted on the retention body 114) for sealing the gap between the retention body 114 and the lid body 116. The fixing member 170 has a roughly rectangular parallelepiped shape and is provided with a plurality of through-holes at a prescribed spacing toward the longitudinal direction. The through-holes pass through from the central part in the width direction of one side surface of the fixing member 170 toward the central part in the width direction of the side surface of the opposite side. The respective through-holes pass through the fixing member 170 in parallel to one another. The through-holes can engage with the outer peripheral surface of the lid body 116. The applicator 110 is detachably attached to the fixing member 170 as a result of the lid body 116 engaging with one of the through-holes.

The material of the fixing member 170 is not particularly limited and may be metal, plastic, glass, or the like. In addition, the fixing member 170 may be transparent or colored.

The shape and size of the fixing member 170 may be selected appropriately in consideration of factors such as the ease of transport, ease of fixing the applicators 110 and 120 to the fixing member 170, and ease of attaching and detaching the applicators 110, 120, 130, 140, 150, and 160 to and from the fixing member 170. For example, the total length of the fixing member 170 along the longitudinal direction of the fixing member 170 in FIG. 7 may be set to 50 to 300 mm.

With such an applicator set 200, it is possible to integrally fix the applicators 110, 120, 130, 140, 150, and 160 to the fixing member 170. In addition, by carrying around the applicator set 200, the transportation of a plurality of applicators becomes easy.

By separating the lid body 116 from the applicator 110, for example, at the time of the application of the marker composition, it is possible to separate the applicator 110 from the applicator set 200 and to open the applicator body 112. By then, for example, gripping the applicator 110 separated from the lid body 116 and pressing the exposed portion of the applicator body 112 against the surface of the application target, it is possible to apply the marker composition retained in the applicator body 112. When the lid body 116 and the fixing member 170 are detachably attached, the lid body 116 may be separated from the applicator 110 so as to apply the marker composition after the applicator 110 is separated from the fixing member 170 in a state in which the lid body 116 is mounted.

After the application of the marker composition, the applicator body 112 of the spent applicator 110 is hermetically sealed by the lid body 116. Next, by separating the lid body 126 from the applicator 120, for example, it is possible to separate the applicator 120 from the applicator set 200 and to open the applicator body 122. By then, for example, gripping the applicator 120 separated from the lid body 126 and pressing the exposed portion of the applicator body 122 against the surface of the application target, it is possible to apply the marker composition retained in the applicator body 122. For example, during use within the hospital room of a hospital, even if a pathogen becomes attached to the applicator body 112 of the applicator 110, the applicator body 112 is hermetically sealed by the lid part 116, so it is possible to prevent the spread of the pathogen to other hospital rooms. In addition, the spread of pathogens due to a contaminated applicator can also be prevented by storing or discarding the applicator 110 used in a given hospital room in the room after use and applying the marker composition in other hospital rooms using the applicator set 200 from which the applicator 110 has been separated.

An example of a method of production of the applicator set 200 is a method comprising: a step of filling the applicator bodies 112, 122, 132, 142, 152, and 162 with the marker composition; a step of mounting the respective applicator bodies 112, 122, 132, 142, 152, and 162 filled with the marker composition to the retention bodies 114, 124, 134, 144, 154, and 164 to obtain the applicators 110, 120, 130, 140, 150, and 160; and a step of fixing the applicators 110, 120, 130, 140, 150, and 160 to the fixing member 170.

The applicator set of the present embodiment is not limited to the aforementioned aspect, and various types of variations are possible. For example, the means of connection between separate applicators and the means of connection between the applicator and the lid body, in the same manner as the applicator of the forth embodiment, may arrange a male thread part at the retention part of the applicator, arrange a female thread part at the lid body and lid part of the applicator, and may perform attachment by screwing together these threaded members. Moreover, the lid part may be shaped so as to be capable of latching with the retention part, for example, by providing the exterior wall face of the retention part with a protuberance part capable of latching with the inner wall face of the lid part. It is possible by such joining means to use the sealing component to seal the gap between the retention part and the lid part and to increase air tightness of the space for hermetically sealing the applicator body. Moreover, the applicator and lid body may each have a fastener to make the applicator and lid body capable of mutual detachable attachment. Furthermore, the applicator set may be inserted and stored in a highly hermetically sealed container (e.g. bag, housing, or the like) in order to further increase storage stability of the marker composition during storage of the applicator set.

In addition, the fixing member is not particularly limited as long as it integrally fixes a plurality of applicators. For example, an adhesive for detachably adhering the applicators to one another may be used as the fixing member.

In addition, no particular limitation is placed on the number of applicators of the applicator set, and a single applicator set may have from 1 to 20 applicators.

### Seventh Embodiment: Method of Determining Degree of Cleanliness

The method of determining the degree of cleanliness of the seventh embodiment comprises: a step of applying the marker composition to the pre-cleaning surface to be cleaned; a step of irradiating light on the post-cleaning surface to be cleaned, and sensing light reflected from retroreflective particles; and a step of determining the degree of cleanliness of the surface to be cleaned based on the results of sensing the reflected light. The marker composition of the first embodiment or the second embodiment may be used as the marker composition in the seventh embodiment. In addition, the method of applying the marker composition is not particularly limited, and it is possible, for example, to use the package of the third embodiment, the applicator of the fourth embodiment, the applicator set of the fifth embodiment, or the applicator set of the sixth embodiment.

In one aspect of the degree of cleanliness determination method of the present embodiment, firstly, the marker composition is applied to an object to be cleaned (e.g. table, chair, or the like) or to the floor, wall, ceiling, or the like prior to cleaning, in a manner so as not to be noticed by the cleaning personnel. Furthermore, if the region of application of the marker composition is not to be known by the cleaning personnel, a transparent composition may be used for the marker composition.

Thereafter, the cleaning personnel perform cleaning. The marker composition may be readily removed from the cleaning region by wiping off using a cleaning tool (e.g. cloth, mop, or the like) that includes water, a mixed solution of water-alcohol, or the like. Furthermore, during application and removal of the marker composition, the marker composition is illuminated by light as natural lighting or indoor lighting. However, since the line of sight of the person holding the cleaning article and cleaning the cleaning region is normally different from the direction of incidence and reflection of light, the person holding the cleaning article and cleaning the cleaning region is normally unable to visually sense reflected light from the retroreflective particles.

Thereafter, light is irradiated onto the post-cleaning surface to be cleaned, light reflected form the retroreflective particles is sensed, and then based on the results of sensing of the reflected light, the degree of cleanliness of the surface to be cleaned is determined. No particular limitation is placed on the illuminating light as long as the illuminating light indicates retroreflectivity of the retroreflective particles. Moreover, if the utilized light is visible light, it is possible to visually sense the reflected light. Alternatively, illumination and imaging may be performed using light emission for imaging (flash lighting) of a normal camera, camera-equipped cellular phone, camera-equipped multi-function type portable phone, or the like; and then based on the presence or absence of reflected light in the obtained image, it is possible to determine the presence or absence of the marker composition.

### Eighth Embodiment: System for Determining Degree of Cleanliness

The system for determining the degree of cleanliness of the eighth embodiment comprises: a sensing means, upon application of the marker composition and thereafter irradiation of light onto the post-cleaning surface to cleaned, for sensing reflected light from retroreflective particles contained in the marker composition based on image data showing condition of the surface to be cleaned; and a determination means for determination of the degree of cleanliness of the surface to be cleaned based on results of sensing the reflected light obtained by the sensing means.

No particular limitation is placed on the image data of the present embodiment, as long as the image data are capable of use in determining the presence or absence of light reflected from the retroreflective particles included in the marker composition means by the sensing means. For example, in the same manner as in the seventh embodiment, light illumination for imaging (flash lighting) of a normal camera, a camera-equipped cellular phone, a camera-equipped multifunctional phone, or the like may be used.

No particular limitation is placed on the sensing means, as long as the sensing means is capable of sensing light reflected from the retroreflective particles included in the marker composition based on the obtained image data. For example, it is possible to use an image analysis device capable of distinguishing the presence or absence of reflected light in the image data. Moreover, during sensing of the reflected light, as may be required, it is possible to perform image processing such as increasing the contrast between the region of reflected light in the image data (bright region) and other regions (dark regions). Processing may also be performed such as the analysis of the surface area and/or shape of the region where there is reflected light. It is possible to determine the degree of cleanliness of the surface to be cleaned with higher accuracy by performing such analysis.

No particular limitation is placed on the determination means, as long as the determination means is able to determine the degree of cleanliness of the surface to be cleaned based on the results of sensing of reflected light obtained by the sensing means. For example, if the sensing means has a function for transmission of a data signal relating to the result of sensing the reflected light, it is possible to use a data processing device having the ability to receive the data signal and having a function for determination that “reflected light is present” or “reflected light is absent” based on the information signal.

Furthermore, by use of a means for information exchange (e.g. intranet, internet, or the like), uniform management of data is possible relating to the results of determination of the degree of cleanliness based on image data or the results of sensing of reflected light obtained at multiple locations. By this means, efficient and accurate determination of whether or not cleaning has been sufficiently performed may be carried out even when the region subject to cleaning extends over a wide range.

A multifunction type device having both a sensing function and determination function may be used for the sensing means and determination means. A camera-equipped multi-function type portable phone may be used as this type of multifunction type device, for example. In this case, firstly, software (i.e. an application) for executing a function for the aforementioned sensing means and determination means is installed in a computer (CPU or the like) within the portable phone. Thereafter, by processing of the image data by the aforementioned software, it is possible to sense light reflected form the retroreflective particles and to perform a determination of the degree of cleanliness of the surface to be cleaned. Software to realize the function of the sensing means and software to realize the function of the determination means may be separate software applications, or may be a single integrated software application.

Moreover, a means for data exchange may be used, and a server computer capable of being accessed (i.e. a so-called cloud system) may be used as the multifunction type device. In this case, firstly software for realizing the functions of the sensing means and determination means is installed in the server computer. Thereafter, the data exchange means is used to send the image data to the server computer. Thereafter, the server computer uses the aforementioned software to perform processing of the image data, and then the processing results are received from the server computer so that, at the cleaning site, it is possible to readily perform sensing of light reflected from the retroreflective particles and determination of the degree of cleanliness of the surface to be cleaned, even when there is no sensing means and determination means at the cleaning site.

### EXAMPLES

Although the present invention is explained more concretely based on working examples, the present invention in no manner is limited by the below working examples.

### Production Examples 1 and 2

### <Preparation of Mixture of Dispersion Medium and Humectant>

The respective water soluble polymers, water, alcohols, and humectants indicated below were used in the Production Examples 1 and 2 to prepare the mixtures of dispersion medium and humectant having the compositions indicated in Table 1. Furthermore, the units of the blended fractions of each of the materials in Table 1 are parts by weight.

Water Soluble Polymer:

X-PVP (produced by Aldrich, water soluble polymer obtained by γ irradiation of polyvinylpyrrolidone to crosslink)

K90-PVP (produced by Wako Pure Chemical Industries, Ltd., non-crosslinked polyvinylpyrrolidone)

Water: deionized water

Alcohol: IPA (isopropyl alcohol)

Humectant: glycerin

The method of preparation of the mixtures of dispersion medium and humectant in the Productions Examples 1 and 2 were as follows.

Firstly, at a temperature of 4 to 6° C., the deionized water and glycerin were placed in a hermetically sealed vessel used for blending of flammable solvents, and the mixture was mixed. Then the water soluble polymer was added, and mixing was continued. Thereafter, temperature of the mixture was raised to 25° C., and then IPA was added to this mixture, and the mixture was blended to obtain the mixture of the dispersion medium and humectant.

### <Measurement of Viscosity of the Dispersion Medium and Humectant>

Viscosity (cps) at 25° C. of the mixture of dispersion medium and humectant of the Production Examples 1 and 2 was measured based on JIS Z 8803. The measurement results are shown in Table 1.

TABLE 1

Production Example

| | | |
|---|---|---|
| Material | 1 | 2 |

| | | | |
|---|---|---|---|
| water soluble | X-PVP | 10 | — |
| polymer | K90-PVP | — | 10 |
| water | deionized water | 35 | 35 |
| alcohol | IPA | 50 | 50 |
| humectant | glycerin | 5 | 5 |

| | | |
|---|---|---|
| viscosity (cps, 25° C.) | 29300 | 8250 |

### Working Examples 1 through 7

### <Preparation of the Marker Composition>

In Working Examples 1 to 7, the marker compositions having the compositions indicated in Table 2 were prepared using retroreflective particles, water soluble polymer, water, alcohol, and humectant. Furthermore, the units of each of the blended fractions of each of the materials in Table 2 are parts by weight. Moreover, details of the materials indicated in Table 2 are described below.

UB-24M (produced by Unitika Ltd., glass particles having 45 to 63 μm particle diameter and 1.9 refractive index)

UB-35M (produced by Unitika Ltd., glass particles having 53 to 75 μm particle diameter and 1.9 refractive index)

The methods of preparation of the marker composition in Working Examples 1 to 7 are described below.

Firstly, at a temperature of 4 to 6° C., the deionized water and glycerin were placed in a hermetically sealed vessel used for blending of flammable solvents, and the mixture was mixed. Thereafter, temperature of the mixture was raised to 25° C., and then IPA was added to this mixture, and the mixture was blended. Then the retroreflective particles were further added, and the mixture was blended to obtain the marker composition.

### <Preparation of the Applicator, and Evaluation of Characteristics of the Marker Composition>

Using each of the marker compositions of the Working Examples 1 to 7, respective applicators were produced. The applicator production procedure is described below.

Firstly, a 96 well microplate (produced by AS ONE Corp., trade name: GDMP-96U) as the receiver, aluminum tape (produced by 3M Corp., trade name: 3M Micro-Plate Sealing Al Tape (#9792)) as the lid body, and a cotton swab (JCB Industry Ltd., trade name: MEN-TIP) as the applicator body were prepared. Next, the marker composition was fed to each of the wells of microplate receiver part from a pump connected to a peristaltic pump. The amount of marker composition per single well was set at 0.3 mL. Furthermore, aluminum tape was attached to the surface of the opening side of the 96 well microplate so that each well was hermetically sealed, to obtain an applicator such as that shown in FIG. 3.

Next, a cotton swab was used to break the aluminum tape above a well, the marker composition was attached to the cotton swab, and the marker composition was applied to a piece of paper. After application of the marker composition, the piece of paper was observed visually, and the application ability (ease of attachment and thickness of the applied marker composition) and rapid drying ability were evaluated. Moreover, the piece of paper after application of the marker composition was evaluated by using a camera to image the state when not illuminated by imaging light and to image the state when illuminated by imaging light, and visual recognition ability (visibility of the marker composition when not illuminated by light) and reflectivity (visibility of the marker composition when illuminated by light) were evaluated based on the obtained images.

The evaluation criteria for each characteristic were as follows.

### (Application Ability)

A: The marker composition is applied very well.

B: The marker composition is applied well.

C: The marker composition is somewhat difficult to attach.

D: The marker composition is thickly applied.

### (Rapid Drying Ability)

A: The marker composition is very easy to dry.

B: The marker composition is easy to dry.

C: The marker composition is difficult to dry.

### (Visual Recognition Ability)

A: The marker composition is very difficult to see.

B: The marker composition is difficult to see.

C: The marker composition is easy to see.

### (Reflectivity)

A: The marker composition is very easy to see.

B: The marker composition is easy to see.

C: The marker composition is difficult to see.

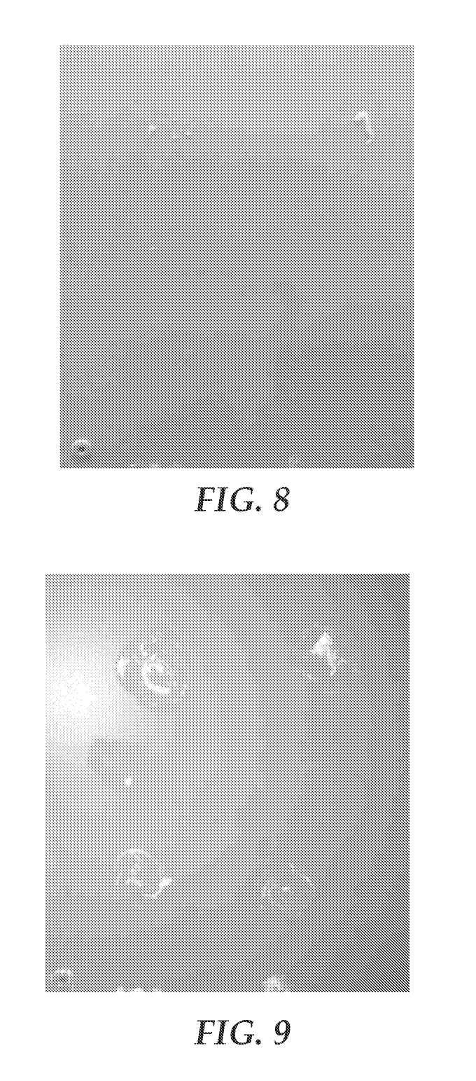

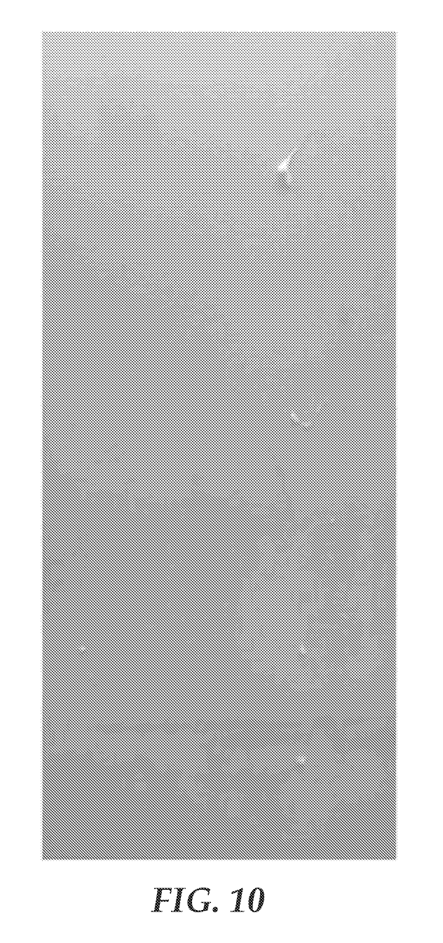

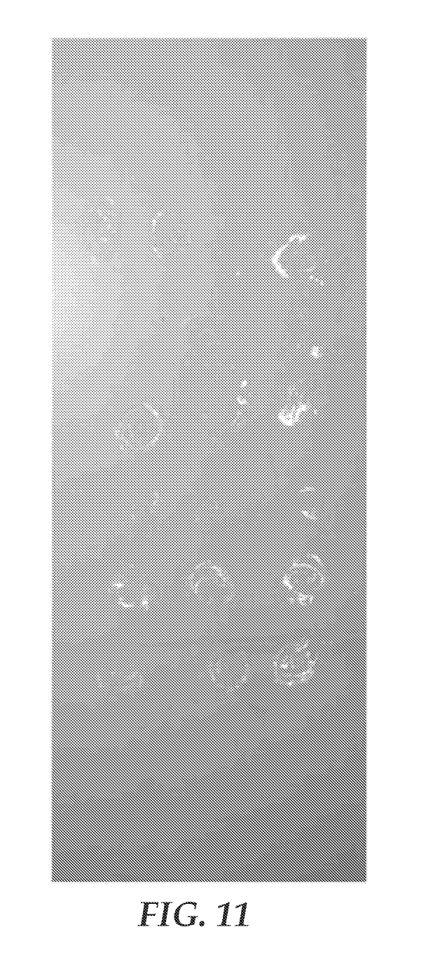

The obtained results of evaluation are shown in Table 2. FIG. 8 shows an image of the state of the piece of paper to which the marker composition of Working Example 3 was applied, when not illuminated by imaging light. FIG. 9 shows an image of the state of the piece of paper to which the marker composition of Working Example 3 was applied, when illuminated by imaging light. FIG. 10 shows an image of the state of the piece of paper to which the marker composition of Working Example 7 was applied, when not illuminated by imaging light. FIG. 11 shows an image of the state of the piece of paper to which the marker composition of Working Example 7 was applied, when illuminated by imaging light. Regarding visibility and reflectivity, there is essentially no difference between the evaluation results obtained when the applied marker composition was observed with the naked eye and the evaluation results based on photographs. For example, when it is not possible to visually confirm the marker composition in an image illustrating a state without irradiation of imaging light, it is also not possible to visually confirm the marker composition with the naked eye.

### <Production of Package, and Evaluation of Marker Composition Characteristics>

Using the marker compositions of the Working Examples 4, 6, and 7, packages were produced. The package production procedure is described below.

Firstly, individual containers (produced by Kaneka Ltd., trade name: COSMOPACK-BP) having a single receiver part as the receiver and aluminum tape (produced by 3M Corp., trade name: 3M Micro-Plate Sealing Al Tape (#9792)) as the lid body were each prepared. Thereafter, the marker composition was fed to the single container receiver parts from a pump connected to a peristaltic pump. The amount of marker composition per single container was set at 0.3 mL. Furthermore, aluminum tape was attached to the surface of the opening side of the individual container so that each container was hermetically sealed, to obtain the package.

Next, the aluminum tape was peeled from the package to open the individual container, the marker composition was attached to a cotton swab, and the marker composition was applied to a piece of paper. The application ability and visual recognition ability were evaluated in the same manner as for the aforementioned applicator.

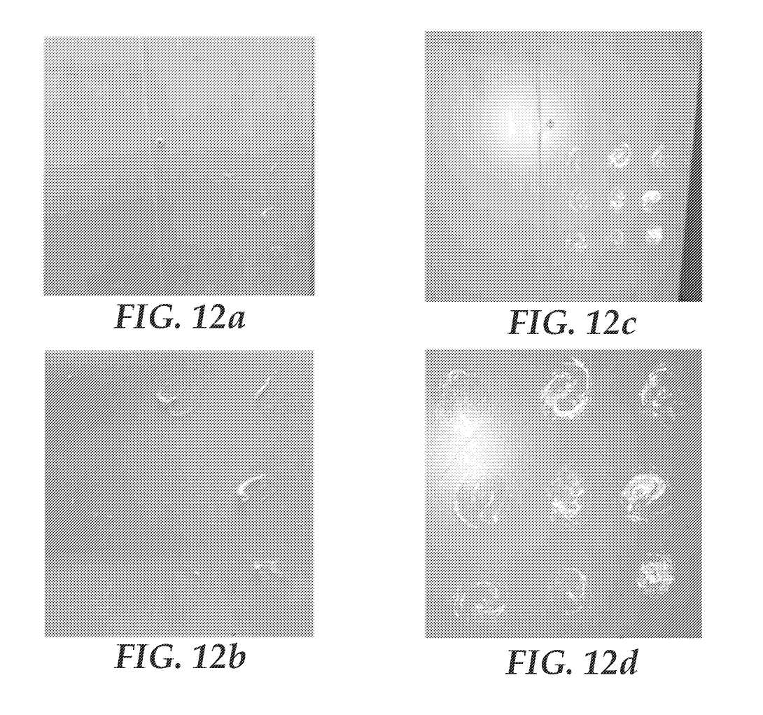

The obtained results of evaluation are shown in Table 2. Moreover, FIG. 12 shows an image of the state of the piece of paper to which the marker composition of Working Example 7 was applied, in the state when not illuminated by imaging light as well as in the state when illuminated by imaging light. In FIG. 12, (a) is an image showing a state without irradiation of imaging light; (b) is an image taken at high magnification in the application area of the marker composition in (a); (c) is an image showing a state with irradiation of imaging light; and (d) is an image taken at high magnification in the application area of the marker composition in (c). Regarding visibility and reflectivity, there is essentially no difference between the evaluation results obtained when the applied marker composition was observed with the naked eye and the evaluation results based on photographs.

TABLE 2

| | | Working Examples | | | | | | |
|---|---|---|---|---|---|---|---|---|
| Material | | 1 | 2 | 3 | 4 | 5 | 6 | 7 |
| particles | UB-24M | 87.6 | 80.0 | 75.0 | 80.0 | 75.4 | — | — |
| | UB-35M | — | — | — | — | — | 80.0 | 80.0 |
| water soluble | X-PVP | 1.24 | — | 2.50 | 2.00 | 2.46 | 1.00 | 1.50 |
| polymer | K90-PVP | — | 2.00 | — | — | — | — | — |
| water | deionized | 4.34 | 7.00 | 8.75 | 7.00 | 8.61 | 13.50 | 10.25 |
| | water | | | | | | | |
| alcohol | IPA | 6.20 | 10.00 | 12.50 | 10.00‘ | 12.30 | 5.00 | 7.50 |
| humectant | glycerin | 0.62 | 1.00 | 1.25 | 1.00 | 1.23 | 0.50 | 0.75 |
| rating | application | C | C | B | D | B | C | A |
| (96 | ability | | | | | | | |
| well | rapid drying | A | A | A | A | A | B | A |
| microplate) | ability | | | | | | | |
| | visual | B | B | B | B | B | B | A |
| | recognition | | | | | | | |
| | ability | | | | | | | |
| | reflectivity | A | A | A | A | A | A | A |
| rating | application | — | — | — | D | — | B | A |
| (separate | ability | | | | | | | |
| containers) | visual | — | — | — | A | — | A | A |
| | recognition | | | | | | | |
| | ability | | | | | | | |

### Working Examples 8 through 11

### <Preparation of the Marker Composition>

Marker compositions having the respective compositions shown in Table 3 were prepared in Working Examples 8 to 11. Furthermore, although the compositions and contents of the ingredients of the marker compositions differed, the preparation procedure of the marker compositions was the same as that of Working Examples 1 to 7. The unit of the blended fractions of each of the materials in Table 3 is parts by weight. “K30-PVP” in Table 3 is non-crosslinked polyvinylpyrrolidone (produced by Wako Pure Chemical Industries, Ltd.).

### <Preparation of the Applicator, and Evaluation of Characteristics of the Marker Composition>

An applicator was produced using a respective marker composition of Working Examples 8 to 11. The applicator production procedure is described below.

Firstly, a polyurethane sponge (produced by INOAC Corp., trade name: CFH-40, interconnected cell count: 40 per 25 mm) was prepared as the applicator body. Next, while stirring the marker composition at 70° C., the marker composition was fed to the sponge from a pump connected to a peristaltic pump, and the inside of the sponge was filled with the marker composition. The amount of marker composition per polyurethane sponge was set at 0.5 to 0.6 g. At this time, the ease of filling the sponge with the marker composition and the retention ability of the marker composition were evaluated. The evaluation criteria are described below.

### (Ease of Filling the Sponge)

A: The sponge is very easy to fill.

B: The sponge is easy to fill.

C: The sponge is somewhat difficult to fill.

### (Sponge Retention Ability)

When the sponge was filled with the marker composition, it was evaluated whether the marker composition is retained well in the sponge on the basis of the following criteria.

A: The marker composition is retained very well.

B: The marker composition is retained well.

C: The marker composition is somewhat difficult to retain.

Thereafter, the sponge was mounted on the retention body, and the lid body and sealing component (O-ring) were mounted on the retention body to obtain a stamp type application as shown in FIG. 4.

Thereafter, the lid body was removed from the applicator to uncover the sponge, and the marker composition was applied by pressing the exposed part of the sponge against a piece of paper. The application ability, visibility, and reflectivity of the marker composition were then evaluated in accordance with the same evaluation criteria as those of Working Examples 1 to 7.

Furthermore, the ease of wiping off the marker composition from a piece of paper and the stability of the marker composition retained in the sponge of the applicator were evaluated on the basis of the following criteria.

### (Ease of Wiping Off)

A: The marker composition is very easy to wipe off.

B: The marker composition is easy to wipe off.

C: The marker composition is somewhat difficult to wipe off.

### (Stability)

It was evaluated on the basis of the following criteria whether the marker composition retained in the sponge is stably retained in the sponge without excessively flowing out of the sponge.

A: The marker composition is retained very stably.

B: The marker composition is retained stably.

C: The marker composition is somewhat difficult to retain stably.

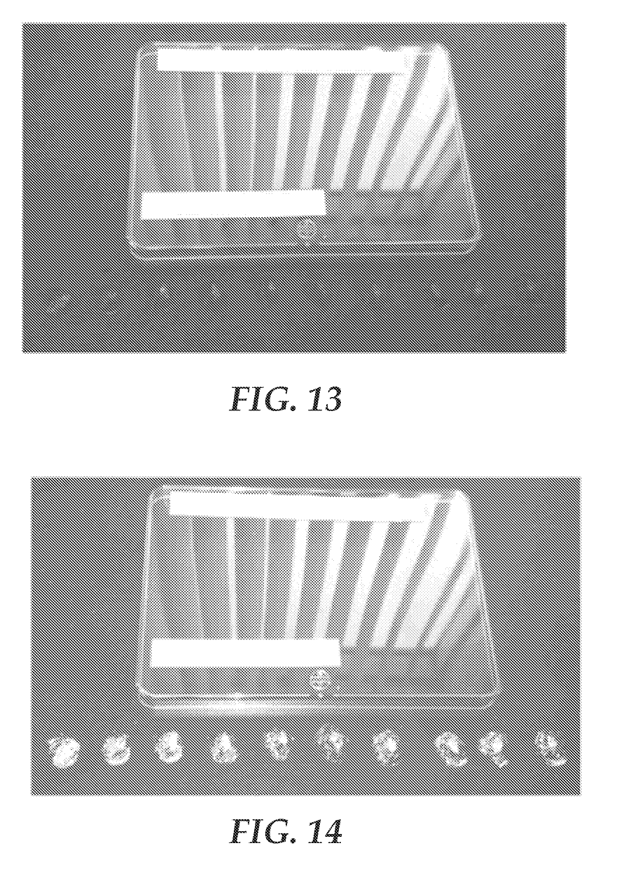

The obtained results of the evaluation are shown in Table 3. FIG. 13 shows an image of the state of the piece of paper to which the marker composition of Working Example 8 was applied, when not illuminated by imaging light. FIG. 14 shows an image of the state of the piece of paper to which the marker composition of Working Example 8 was applied, when illuminated by imaging light. The multiple transfers of the marker composition in FIGS. 13 and 14 were made using the same applicator. Regarding visibility and reflectivity, there is essentially no difference between the evaluation results obtained when the applied marker composition was observed with the naked eye and the evaluation results based on photographs.

TABLE 3

| | | Working Examples | | | |
|---|---|---|---|---|---|
| Material | | 8 | 9 | 10 | 11 |
| particles | UB-24M | — | — | 80.0 | — |
| | UB-35M | 80.0 | 80.0 | — | 80.0 |
| water soluble | X-PVP | — | — | — | 1.50 |
| polymer | K-90PVP | 2.00 | 1.50 | — | — |
| | K-30PVP | — | — | 2.00 | — |
| water | deionized | 7.00 | 10.25 | 7.00 | 10.25 |
| | water | | | | |
| alcohol | IPA | 10.00 | 7.50 | 10.00 | 7.50 |
| humectant | glycerin | 1.00 | 0.75 | 1.00 | 0.75 |
| rating | ease of filling | B | C | B | A |
| | retention ability | A | A | A | A |
| | application ability | A | A | C | C |
| | visual recognition | A | A | A | A |
| | ability | | | | |
| | reflectivity | A | A | B | B |
| | ease of wiping off | A | A | A | A |
| | stability | A | A | A | A |

### Production Examples 3 to 5

Marker compositions were made using the blend concentrations of each of the ingredients and the combination of water soluble polymer, water, alcohol, humectant, and pH adjustment agent as shown in Table 4. Furthermore, the units of blend fraction for each of the materials in Table 4 was parts by weight. “PVA#1400” in Table 4 is polyvinylalcohol (produced by Kishida Chemical Co., Ltd., trade name: Polyvinylalcohol 1,400).

TABLE 4

| | | Production Example | | |
|---|---|---|---|---|
| Material | | 3 | 4 | 5 |
| water soluble polymer | hydroxyethyl | 5 | — | — |
| | cellulose | | | |
| | hydroxypropyl | — | 5 | — |
| | methyl cellulose | | | |
| | phthalate | | | |
| | PVA#1400 | — | — | 5 |
| water | deionized water | 67.5 | 40.0 | 67.5 |
| alcohol | IPA | 25 | 50 | 25 |
| humectant | glycerin | 2.5 | — | 2.5 |
| pH adjustment agent | 0.6M NaOH | — | 5.0 | — |

### Working Examples 12 through 14

### <Preparation of the Marker Composition>

Marker compositions having the respective compositions shown in Table 5 were prepared in Working Examples 12 to 14. Furthermore, the preparation procedure of the marker composition was the same as in Working Examples 1 to 7. Moreover, the units of blend fractions of each of the materials in Table 5 are parts by weight.

### <Preparation of the Applicator, and Evaluation of Characteristics of the Marker Composition>

Using each of the marker compositions of the Working Examples 12 to 14, respective applicators were produced. The preparation procedure of the applicator was the same as in Working Examples 8 to 11. Using the obtained applicator, the marker composition was applied to a piece of paper at a temperature of 4° C., 25° C., or 40° C., and the reflectivity of the marker composition was evaluated in accordance with the same evaluation criteria as in Working Examples 1 to 7.

Furthermore, the attachability of the marker composition (strength of the adhesion to the piece of paper) and the ease of wiping away from the piece of paper were evaluated based on the following evaluation criteria.

### (Attachability)

A: The marker composition is attached well.

B: The marker composition is somewhat difficult to attach.

C: The marker composition is very strongly attached.

### (Ease of Wiping Off)

A: The marker composition is very easy to wipe off.

B: The marker composition spreads out but is easy to wipe off.

C: The marker composition is somewhat difficult to wipe off.

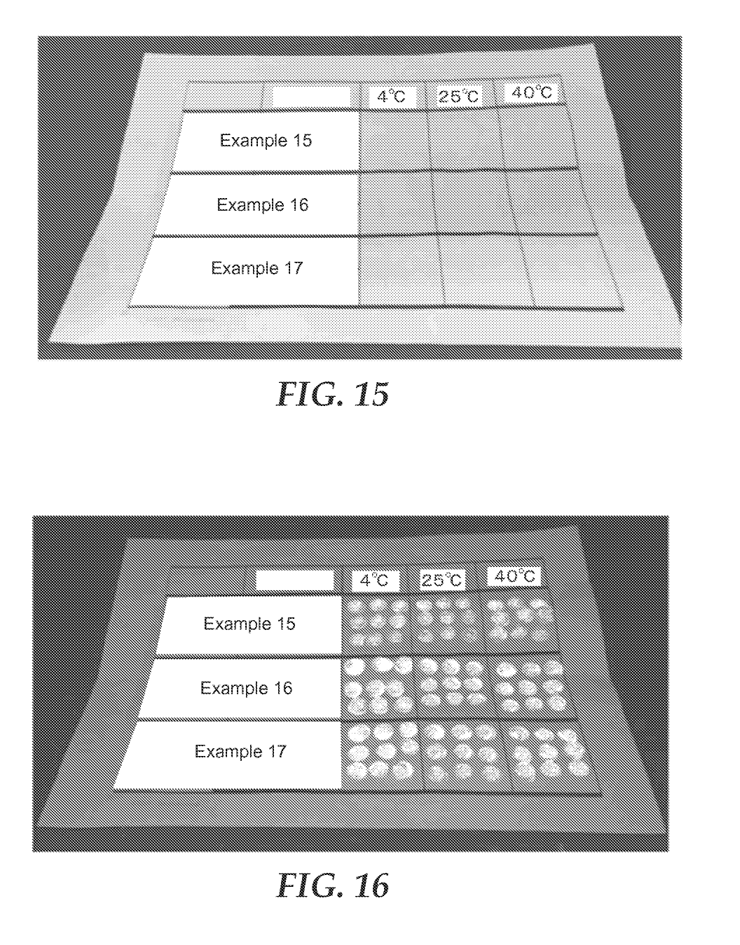

The obtained results of evaluations are shown in Table 5. Moreover, FIG. 15 shows an image of the state of the piece of paper to which the marker compositions of Working Examples 12 to 14 were applied, when not illuminated by imaging light. FIG. 16 shows an image of the state of the piece of paper to which the marker compositions of Working Examples 12 to 14 were applied, when illuminated by imaging light. The multiple transfers of the marker compositions in FIGS. 15 and 16 at each temperature in Working Examples 12 to 11 were made using the same respective applicator. Regarding reflectivity, there is essentially no difference between the evaluation results obtained when the applied marker composition was observed with the naked eye and the evaluation results based on photographs.

TABLE 5

| | | | Working Examples | | |
|---|---|---|---|---|---|
| Material | | | 12 | 13 | 14 |
| particles | UB-35M | | 80.0 | 80.0 | 80.0 |
| water soluble polymer | K-90PVP | | 2.0 | 1.0 | 0.6 |
| water | deionized water | | 17.0 | 17.0 | 15.4 |
| humectant | glycerin | | 1.0 | 2.0 | 4.0 |
| rating | state of the composition | | solid | solid | thick |
| | (25° C.) | | | | putty- |
| | | | | | like |
| | attachability | | C | A | B |
| | reflectivity | 4° C. | A | A | A |
| | | 25° C. | A | A | A |
| | | 40° C. | A | A | A |
| | ease of | 4° C. | C | A | B |
| | wiping off | 25° C. | C | A | B |
| | | 40° C. | C | A | B |

### Working Examples 15 and 16

### <Preparation of the Marker Composition>

In Working Examples 15 and 16, the marker compositions having the compositions indicated in Table 6 were prepared using the respective retroreflective particles and dispersion mediums indicated below. Furthermore, the units of the blended fractions of each of the materials in Table 6 are parts by weight.

Retroreflective Particles:

UB-24M (produced by Unitika Ltd., glass particles having 45 to 63 μm particle diameter and 1.9 refractive index)

Dispersion Medium:

Pluronic (registered trademark) 25R4 (produced by the BASF, pour point: 25° C.)

Poloxamer 188 (produced by Merck & Co., Inc., pour point: 52° C.)

Here, the marker compositions of Working Examples 15 and 16 were prepared by loading and mixing the retroreflective particles and the dispersion mediums in a planetary mixer at a temperature of 90° C. The resulting marker compositions were then maintained at a temperature of 70 to 90° C. and used in the production of the following applicator sets.

### <Production of Applicator Sets and Evaluation of Marker Compositions>

Applicators were produced using the respective marker compositions of Working Examples 15 and 16. The applicator production procedure is described below.

First, a polyurethane sponge (produced by INOAC Corp., trade name: MF-50, cell count: 50 cells/25 mm) was prepared as an applicator body. Next, while stirring the marker composition at 70° C., the marker composition was fed to the sponge from a pump connected to a peristaltic pump, and the inside of the sponge was filled with the marker composition. The amount of marker composition per polyurethane sponge was set at 0.5 to 0.8 g. At this time, the retention ability of the marker composition in the sponge was evaluated.

The sponge was then mounted on the retention body to obtain an applicator, and a plurality of applicators and a lid body were linked to one another to obtain a multi-stamp type applicator set such as that illustrated in FIG. 5.

Next, the lid body was separated from the applicator disposed on the tip to uncover the sponge, and the marker composition was applied by pressing the exposed portion of the sponge against a piece of paper. Furthermore, a series of steps comprising separating the spent applicator from the tip of the applicator set, mounting the applicator to the end of the applicator set, and applying the marker composition was repeated, and the application ability of the marker composition (uniformity of the thickness of the applied marker composition), the ease of exchanging applicators, and the recoatability when applied with a new applicator were evaluated. Moreover, the piece of paper after application of the marker composition was evaluated by using a camera to image the state when not illuminated by imaging light and to image the state when illuminated by imaging light, and visual recognition ability (visibility of the marker composition when not illuminated by light) and reflectivity (visibility of the marker composition when illuminated by light) were evaluated based on the obtained images.

Furthermore, the ease of wiping off the marker composition from a piece of paper and the stability of the marker composition retained in the sponge of the applicator were evaluated.

The evaluation criteria for each characteristic were as follows.

### (Sponge Retention Ability)

When the sponge was filled with the marker composition, it was evaluated whether the marker composition is retained well in the sponge on the basis of the following criteria.

A: The marker composition is retained very well.

B: The marker composition is retained well.

C: The marker composition is somewhat difficult to retain.

### (Application Ability)

A: The marker composition is applied very uniformly.

B: The marker composition is applied uniformly.

C: The marker composition is somewhat difficult to apply uniformly.

### (Visual Recognition Ability)

A: The marker composition is very difficult to see.

B: The marker composition is difficult to see.

C: The marker composition is easy to see.

### (Reflectivity)

A: The marker composition is very easy to see.

B: The marker composition is easy to see.

C: The marker composition is difficult to see.

### (Ease of Wiping Off)

A: The marker composition is very easy to wipe off.

B: The marker composition is easy to wipe off.

C: The marker composition is somewhat difficult to wipe off.

### (Stability)

It was evaluated on the basis of the following criteria whether the marker composition retained in the sponge is stably retained in the sponge without excessively flowing out of the sponge.

A: The marker composition is retained very stably.

B: The marker composition is retained stably.

C: The marker composition is somewhat difficult to retain stably.

### (Ease of Replacing Applicator)

A: The applicator is very easy to replace.

B: The applicator is easy to replace.

C: The applicator is difficult to replace.

### (Recoatability)

A: Very easy to recoat.

B: Easy to recoat.

C: Difficult to recoat.

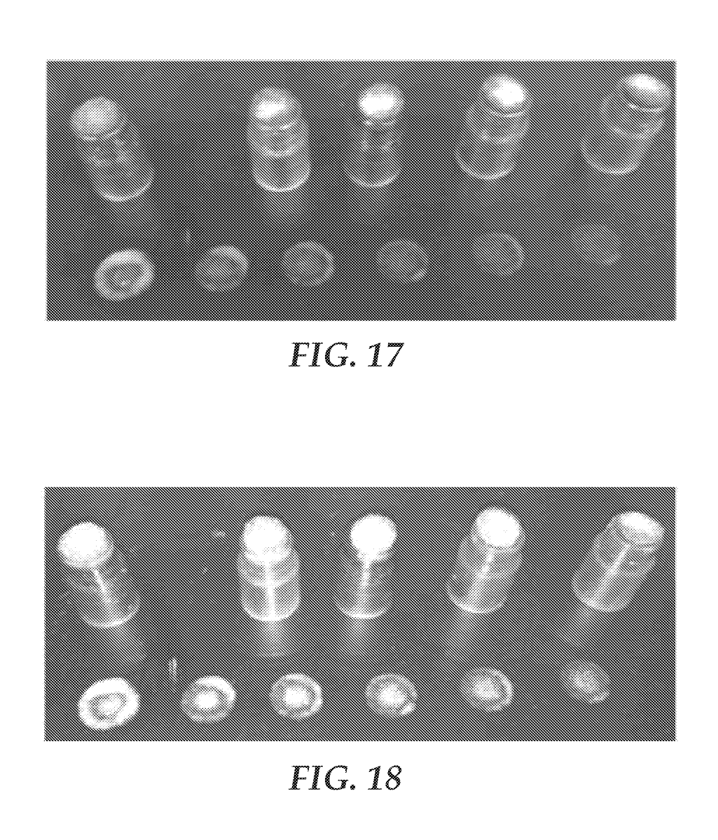

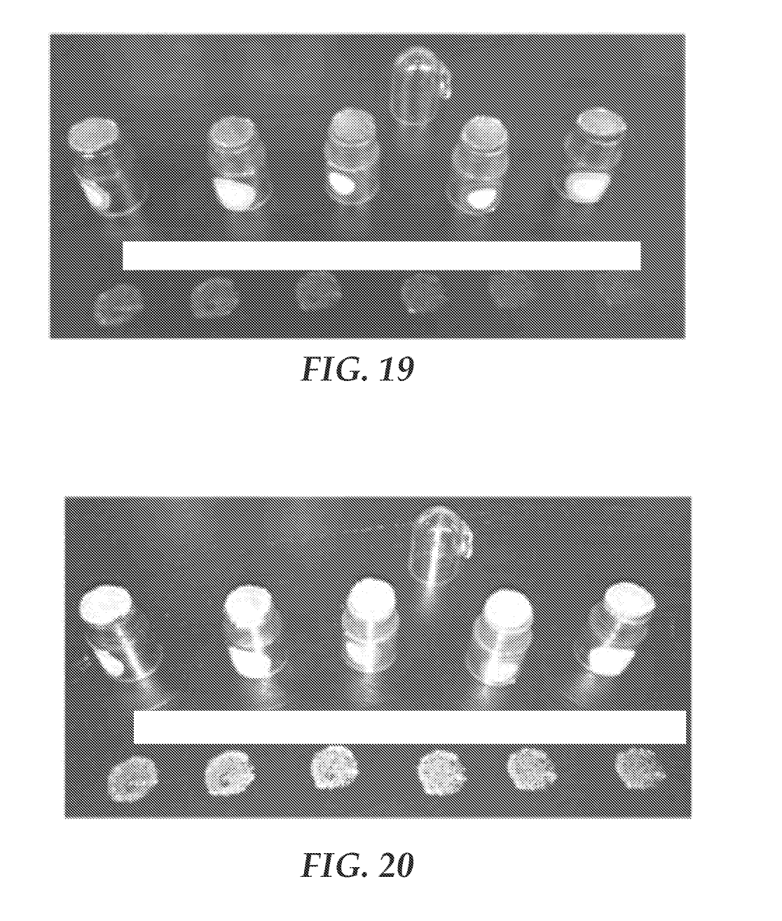

The obtained results of evaluation are shown in Table 6. In addition, FIG. 17 shows an image of the state of the applicator produced using the marker composition of Working Example 15 and a piece of paper to which the marker composition of Working Example 15 was applied, without irradiation of imaging light. FIG. 18 shows an image of the state of the applicator produced using the marker composition of Working Example 15 and a piece of paper to which the marker composition of Working Example 15 was applied, with irradiation of imaging light. Moreover, FIG. 19 shows an image of the state of the applicator produced using the marker composition of Working Example 16 and a piece of paper to which the marker composition of Working Example 16 was applied, without irradiation of imaging light. FIG. 20 shows an image of the state of the applicator produced using the marker composition of Working Example 16 and a piece of paper to which the marker composition of Working Example 16 was applied, with irradiation of imaging light. The multiple transfers of the marker compositions in FIGS. 17 to 20 were respectively made using the same applicator. Regarding visibility and reflectivity, there is essentially no difference between the evaluation results obtained when the applied marker composition was observed with the naked eye and the evaluation results based on photographs.

TABLE 6

Working Examples

| | | |
|---|---|---|
| Material | 15 | 16 |

| | | | |
|---|---|---|---|
| particles | UB-24M | 70 | 70 |
| dispersion | Pluronic 25R4 | 30 | — |
| medium | Poloxamer 188 | — | 30 |
| rating | state of the composition | paste | wax |
| | (25° C.) | | |
| | retention ability | A | A |
| | application ability | A | A |
| | visual recognition ability | B | A |
| | reflectivity | A | A |
| | ease of wiping off | A | A |
| | stability | C | A |
| | ease of replacement | A | A |
| | recoatability | A | A |

### <Production of Applicator Sets and Evaluation of Physical Properties of Marker Compositions>

With the exception of changing the sponge used for a stamp (urethane foam) to the sponges indicated in Table 7, applicator sets were obtained using the marker composition of Working Example 15 in the same manner as in Working Example 15. The details of the materials indicated in Table 7 are as follows.

MF-20: produced by the Inoac Corporation, polyester urethane foam, trade name, cell count: 20 cells/25 mm

MF-30: produced by the Inoac Corporation, polyester urethane foam, trade name, cell count: 30 cells/25 mm

CFH-30: produced by the Inoac Corporation, polyester urethane foam, trade name, cell count: 30 cells/25 mm

CFH-40: produced by the Inoac Corporation, polyester urethane foam, trade name, cell count: 40 cells/25 mm

MF-50: produced by the Inoac Corporation, polyester urethane foam, trade name, cell count: 50 cells/25 mm

MF-55: produced by the Inoac Corporation, polyester urethane foam, trade name, cell count: 55 cells/25 mm

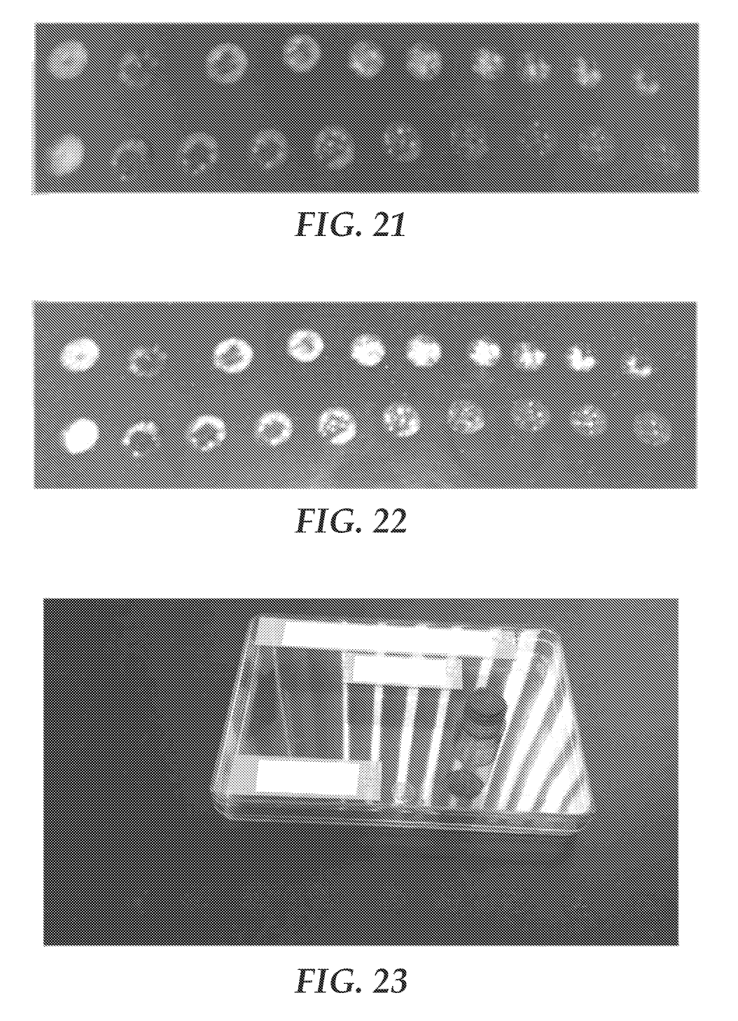

Next, using the applicator of the obtained applicator set, the marker composition of Working Example 15 was applied 10 times to a piece of paper, and the retention ability and application ability were evaluated. The obtained results are shown in Table 7. In addition, when an applicator having CFH-30 or CFH-40 as a sponge was used, an image of the state of a piece of paper to which the marker composition of Working Example 15 was applied, without irradiation of imaging light, is shown in FIG. 21, and an image of the state of a piece of paper to which the marker composition of Working Example 15 was applied, with irradiation of imaging light, is shown in FIG. 22. Here, in FIGS. 21 and 22, the upper level indicates the results for CFH-30, and the lower level indicates the results for CFH-40. In FIGS. 21 and 22, the multiple transfers of the marker compositions when each sponge was used were respectively made using the same applicator.

TABLE 7

| | | Working Examples 15 | | | | | |
|---|---|---|---|---|---|---|---|
| Material | | MF- | MF- | CFH- | | | |
| sponge | | 20 | 30 | 30 | CFH-40 | MF-50 | MF-55 |
| cell count | | 20 | 30 | 30 | 40 | 50 | 55 |
| (cells/25 mm) | | | | | | | |
| rating | retention | A | A | A | A | B | C |
| | ability | | | | | | |
| | application | C | B | B | A | A | A |
| | ability | | | | | | |

### Working Examples 17 through 20

### <Preparation of the Marker Composition>

Marker compositions having the respective compositions shown in Table 8 were prepared in Working Examples 17 to 20. The details of the materials indicated in Table 8 are as follows. Moreover, the units of blend fractions of each of the materials in Table 8 are parts by weight.

Pluronic 25R4: produced by the BASF, trade name, pour point: 25° C.

Pluronic P84: produced by the BASF, trade name, pour point: 34° C.

Pluronic P103: produced by the BASF, trade name, pour point: 30° C.

Poloxamer 188: produced by Merck & Co., Inc., trade name, pour point: 52° C.

### <Production of Applicator Sets and Evaluation of Physical Properties of Marker Compositions>

Applicator sets were produced using the respective marker compositions of Working Examples 17 to 20. The production procedure for the applicator sets is the same as in the case of Working Examples 15 and 16 with the exception of changing the sponge to MF-55. Next, using the obtained applicator sets, the marker compositions of Working Examples 20 to 23 were applied to pieces of paper. The retention ability, application ability, visibility, reflectivity, ease of wiping off, stability, ease of replacement, and recoatability of the marker compositions were then evaluated in accordance with the same evaluation criteria as in Working Examples 15 and 16.

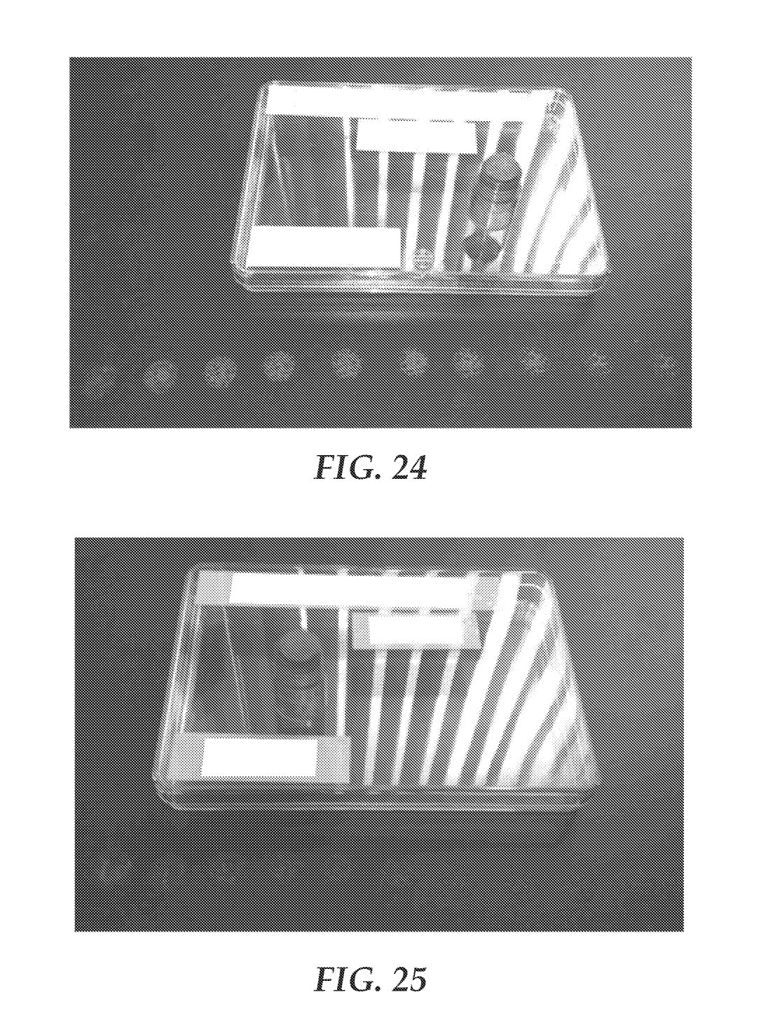

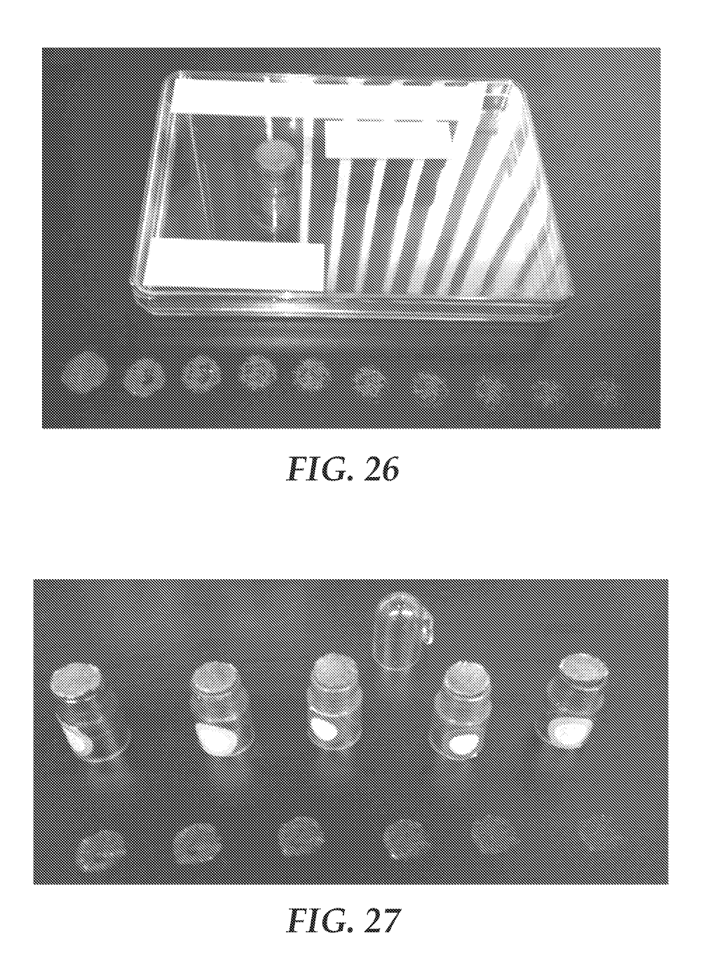

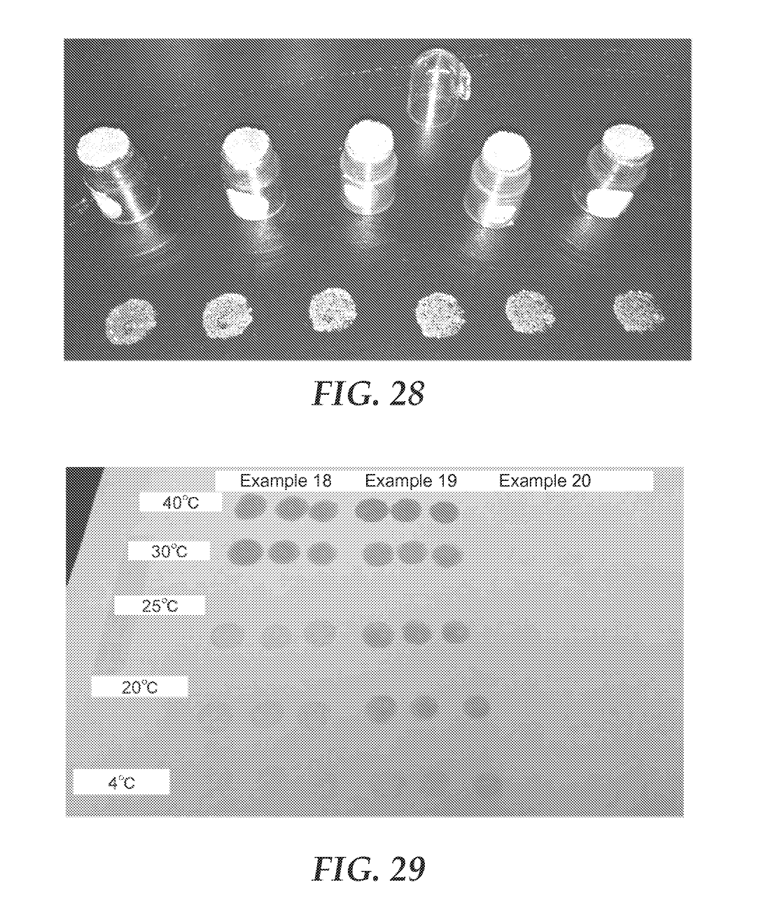

The obtained results are shown in Table 8. In addition, FIG. 23 shows an image of the state of the applicator produced using the marker composition of Working Example 21 and a piece of paper to which the marker composition of Working Example 18 was applied, without irradiation of imaging light. FIG. 24 shows an image of the state of the applicator produced using the marker composition of Working Example 21 and a piece of paper to which the marker composition of Working Example 18 was applied, with irradiation of imaging light. In addition, FIG. 25 shows an image of the state of the applicator produced using the marker composition of Working Example 19 and a piece of paper to which the marker composition of Working Example 19 was applied, without irradiation of imaging light. FIG. 26 shows an image of the state of the applicator produced using the marker composition of Working Example 19 and a piece of paper to which the marker composition of Working Example 19 was applied, with irradiation of imaging light. In addition, FIG. 27 shows an image of the state of the applicator produced using the marker composition of Working Example 20 and a piece of paper to which the marker composition of Working Example 20 was applied, without irradiation of imaging light. FIG. 28 shows an image of the state of the applicator produced using the marker composition of Working Example 20 and a piece of paper to which the marker composition of Working Example 20 was applied, with irradiation of imaging light. In FIGS. 23 to 28, multiple transfers of the marker compositions of Working Examples 18 to 20 were respectively made using the same applicator. Regarding visibility and reflectivity, there is essentially no difference between the evaluation results obtained when the applied marker composition was observed with the naked eye and the evaluation results based on photographs.

TABLE 8

| | | Working Examples | | | |
|---|---|---|---|---|---|
| Material | | 17 | 18 | 19 | 20 |
| particles | UB-24M | 70 | 70 | 70 | 70 |
| dispersion | Pluronic 25R4 | 30 | — | — | — |
| medium | Pluronic P84 | — | 30 | — | — |
| | Pluronic P103 | — | — | 30 | — |
| | Poloxamer 188 | — | — | — | 30 |
| rating | state of the composition | paste | paste | paste | wax |
| | (25° C.) | | | | |
| | retention ability | A | A | A | A |
| | application ability | A | B | B | C |
| | visual recognition ability | B | B | B | B |
| | reflectivity | A | A | A | A |
| | ease of wiping off | A | A | A | A |
| | stability | B | A | A | A |
| | ease of replacement | A | A | A | A |
| | recoatability | A | A | A | A |

Next, when the temperature of the piece of paper was 40° C., 30° C., 25° C., 20° C., or 4° C., the respective marker compositions of Working Examples 18 to 20 were applied three times each to a white piece of paper. The application ability of the marker compositions on the piece of paper at each temperature was then evaluated in accordance with the same evaluation criteria as those of Working Examples 15 and 16. In addition, the state of the marker composition on the piece of paper was evaluated using the following criteria.

### (State of the Marker Composition on the Piece of Paper)

A: The marker composition is a solid.

B: The marker composition is somewhat liquid-like.

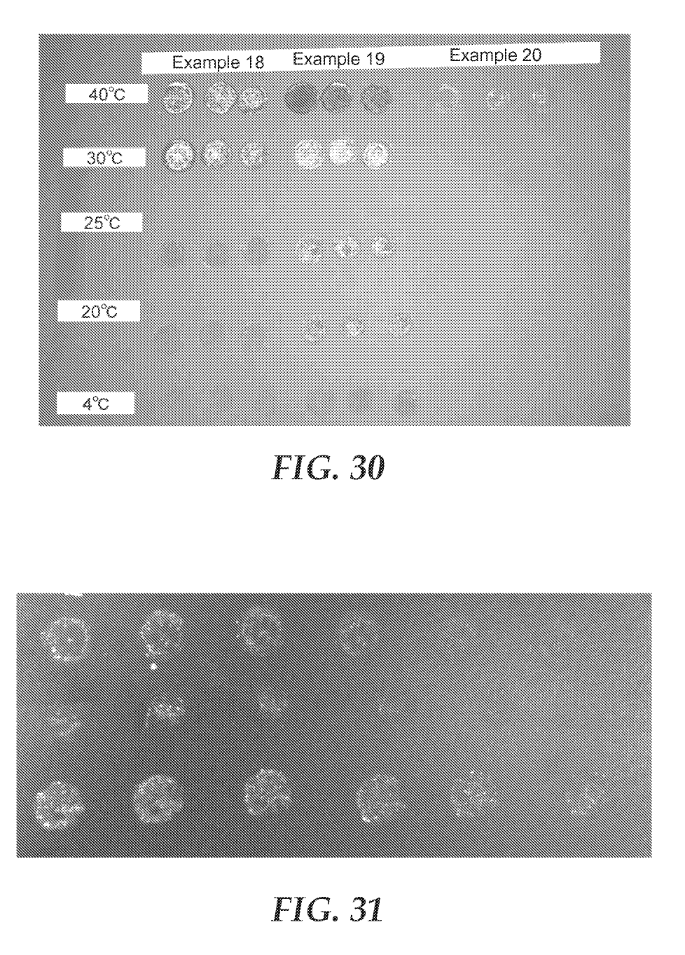

The evaluation results are shown in Table 9. In addition, FIG. 29 shows an image of the state of the piece of paper to which the marker compositions of Working Examples 18 to 20 were applied, without irradiation of imaging light. FIG. 30 shows an image of the state of the piece of paper to which the marker compositions of Working Examples 18 to 20 were applied, with irradiation of imaging light. When the temperature of the piece of paper was 30° C., 25° C., 20° C., and 4° C., the marker composition of Working Example 20 was transferred negligibly to the piece of paper. The multiple transfers of the marker compositions in FIGS. 29 and 30 at each temperature in Working Examples 18 to 20 were made using the same respective applicator.

TABLE 9

Working Examples

| | | | |
|---|---|---|---|
| Material | 18 | 19 | 20 |

| | | | | | |
|---|---|---|---|---|---|
| rating | application ability | 40° C. | A | A | B |
| | | 30° C. | A | A | C |
| | | 25° C. | B | A | C |
| | | 20° C. | B | A | C |
| | | 4° C. | B | B | C |
| | state on the piece | 40° C. | B | B | A |
| | of paper | 30° C. | B | B | — |
| | | 25° C. | A | B | — |
| | | 20° C. | A | B | — |
| | | 4° C. | A | A | — |

Next, with the exception of changing the sponge to the sponges indicated in Table 10, applicator sets were produced using the marker composition of Working Example 17 in the same manner as in Working Examples 15 and 16. The marker composition was applied to a piece of paper using the applicator of the obtained applicator set. The retention ability, application ability, and stability were evaluated in accordance with the same evaluation criteria as in Working Examples 15 and 16. The obtained results are shown in Table 10.

TABLE 10

| | | Working Example 17 | | | |
|---|---|---|---|---|---|
| | | sponge | | | |
| Material | | CFH-30 | CFH-40 | MF-50 | MF-55 |
| cell count (cells/25 mm) | | 30 | 40 | 50 | 55 |
| rating | retention ability | A | A | A | A |
| | application ability | B | A | A | A |
| | stability | C | C | C | B |

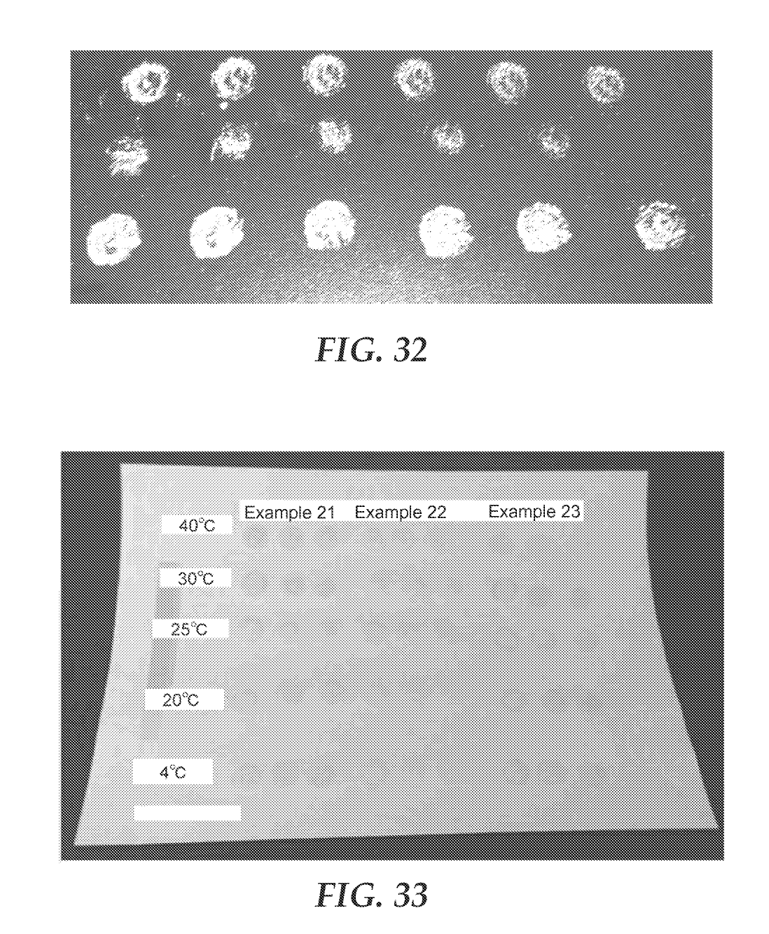

Next, with the exception of changing the sponge to the sponges indicated in Table 11, applicator sets were produced using the marker composition of Working Example 20 in the same manner as in Working Examples 15 and 16. The marker composition was applied to a piece of paper using the applicator of the obtained applicator set. The retention ability, application ability, and stability were evaluated in accordance with the same evaluation criteria as in Working Examples 15 and 16. The obtained results are shown in Table 11. In addition, when applicators having MF-20, CFH-40, and MF-50 as sponges were used, an image of the state of a piece of paper to which the marker composition of Working Example 20 was applied, without irradiation of imaging light, is shown in FIG. 31, and an image of the state of a piece of paper to which the marker composition of Working Example 20 was applied, with irradiation of imaging light, is shown in FIG. 32. Here, in FIGS. 31 and 32, the upper level indicates the results for CFH-40, the middle level indicates the results for MF-20, and the lower level indicates the results for MF-50. In FIGS. 31 and 32, the multiple transfers of the marker compositions when each sponge was used were respectively made using the same applicator.

TABLE 11

| Material | | Working Example 20 | | | | |
|---|---|---|---|---|---|---|
| sponge | | MF-20 | MF-30 | CFH-30 | CFH-40 | MF-50 |
| cell count | | 20 | 30 | 30 | 40 | 50 |
| (cells/25 mm) | | | | | | |
| rating | retention | A | A | A | A | B |
| | ability | | | | | |
| | application | C | B | B | A | A |
| | ability | | | | | |
| | stability | C | A | A | A | A |

### Working Examples 21 through 30

### <Preparation of the Marker Composition>

In Working Examples 21 to 30, marker compositions respectively containing 70 parts by mass of UB-35M (produced by Unitika Ltd., trade name) and 30 parts by mass of a dispersion medium having the composition indicated in Table 12 were prepared. The unit of the blended fractions of each of the materials in Table 12 is parts by weight. “PEG#600” in Table 12 is polyethylene glycol (produced by Wako Pure Chemical Industries, Ltd.), and “PPG#1400” is polypropylene glycol (produced by Wako Pure Chemical Industries, Ltd.). In addition, all of the dispersion mediums contained in the marker compositions of Working Examples 21 to 30 have pour points within the range of from 0 to 60° C. For example, the pour point of the dispersion medium contained in the marker composition of Working Example 22 is 38° C.

### <Production of Applicator Sets and Evaluation of Physical Properties of Marker Compositions>

Applicator sets were produced using the respective marker compositions of Working Examples 21 to 30. The production procedure for the applicator sets is the same as in the case of Working Examples 15 and 16 with the exception of changing the sponge to MF-55. Next, using the applicators of the obtained applicator sets, the marker compositions of Working Examples 21 to 30 were applied to white pieces of paper. The reflectivity of the marker composition and the state of the marker composition on the piece of paper at a paper temperature of 40° C., 30° C., 25° C., 20° C., and 4° C. were then evaluated in accordance with the same evaluation criteria as in Working Examples 15 to 20.

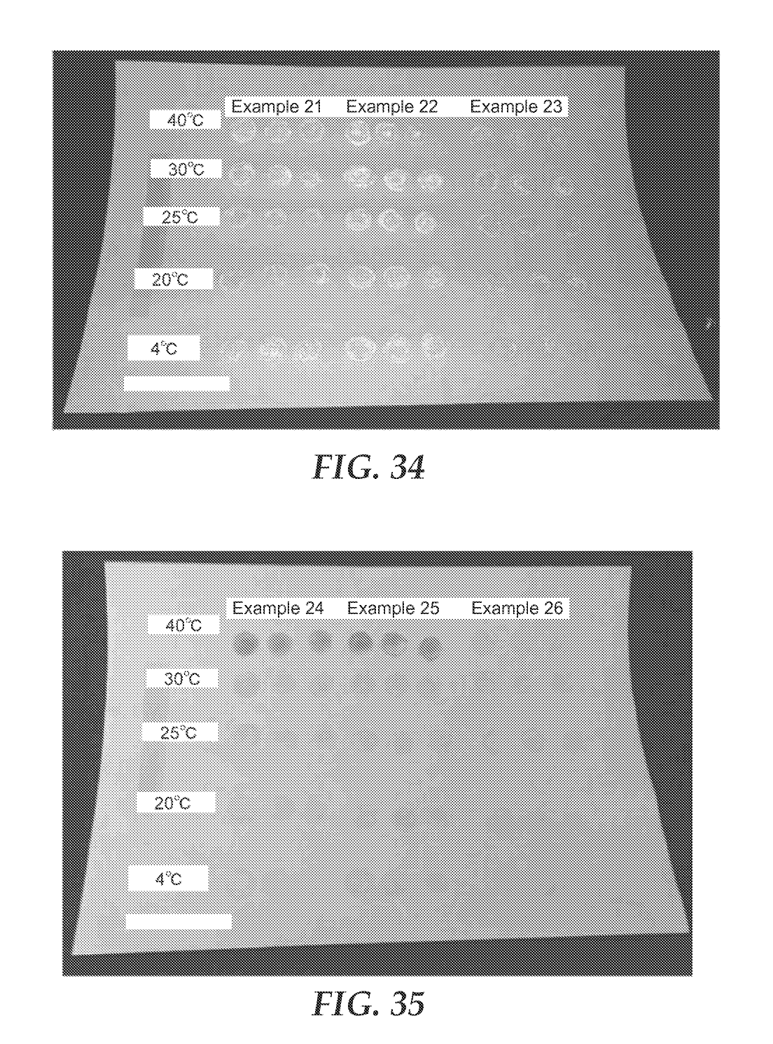

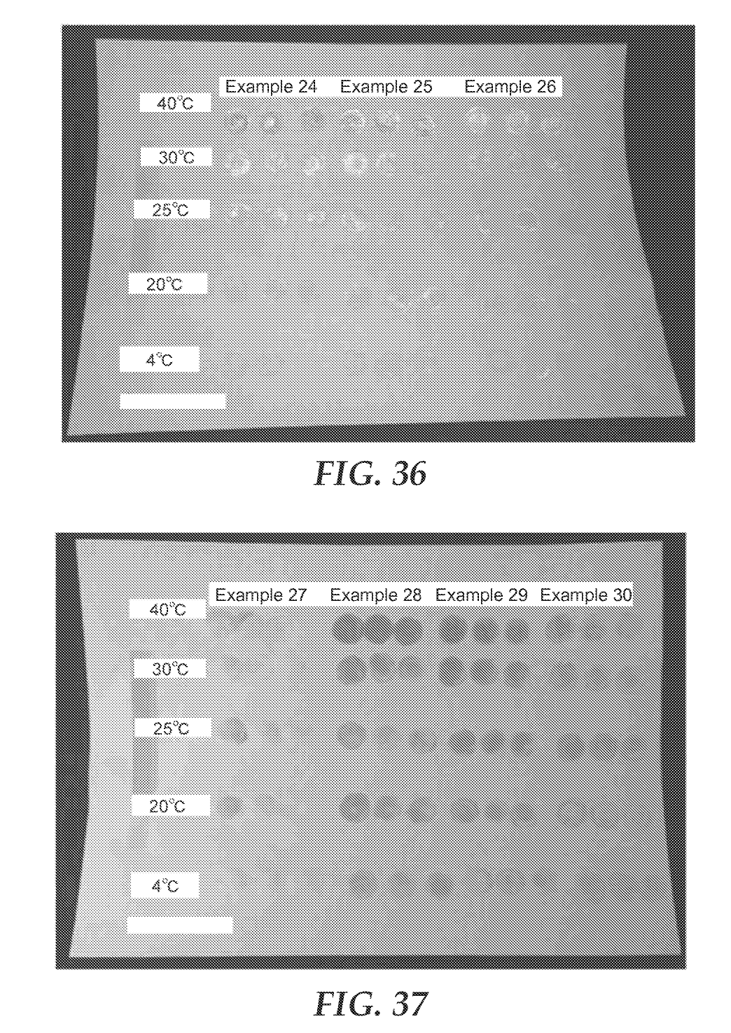

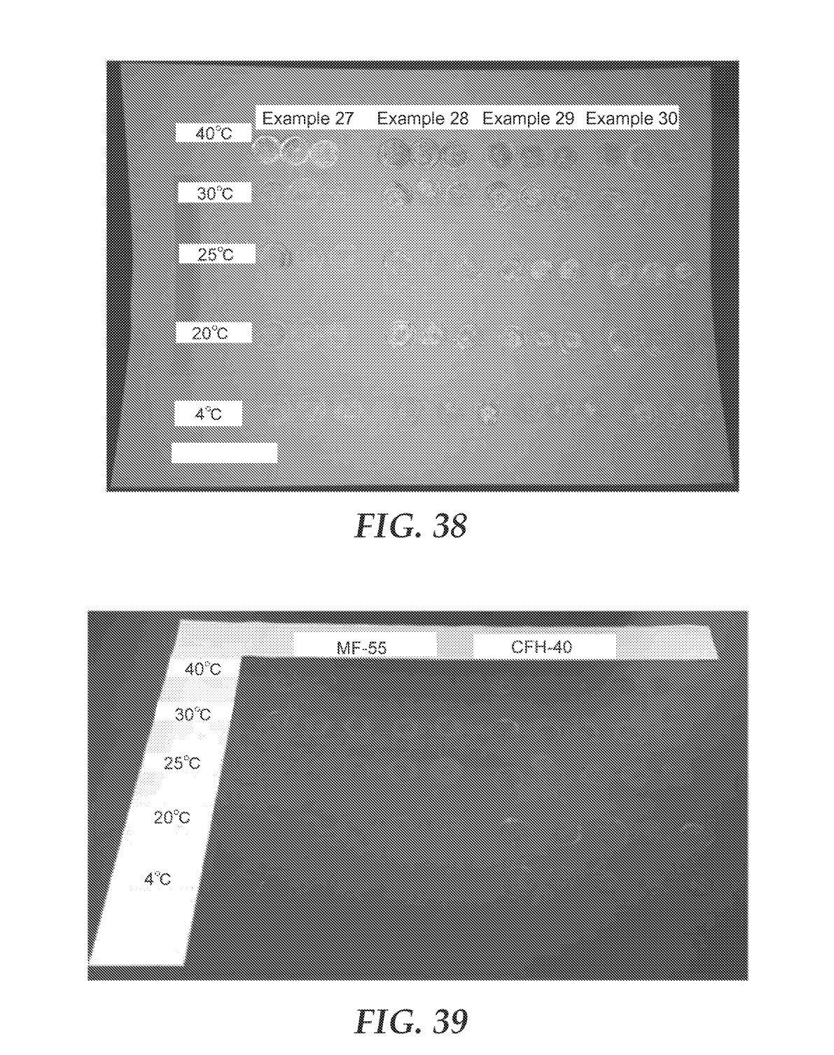

The obtained results are shown in Table 12. In addition, FIG. 33 shows an image of the state of the piece of paper to which the marker compositions of Working Examples 21 to 23 were applied, without irradiation of imaging light. FIG. 34 shows an image of the state of the piece of paper to which the marker compositions of Working Examples 21 to 23 were applied, with irradiation of imaging light. In addition, FIG. 35 shows an image of the state of the piece of paper to which the marker compositions of Working Examples 24 to 26 were applied, without irradiation of imaging light. FIG. 36 shows an image of the state of the piece of paper to which the marker compositions of Working Examples 24 to 26 were applied, with irradiation of imaging light. In addition, FIG. 37 shows an image of the state of the piece of paper to which the marker compositions of Working Examples 27 to 30 were applied, without irradiation of imaging light. FIG. 38 shows an image of the state of the piece of paper to which the marker compositions of Working Examples 27 to 30 were applied, with irradiation of imaging light. In FIGS. 33 to 38, the multiple transfers of the marker compositions of Working Examples 21 to 30 at each temperature were respectively made using the same applicator. There is essentially no difference between the evaluation results obtained when the applied marker composition was observed with the naked eye and the evaluation results based on photographs.

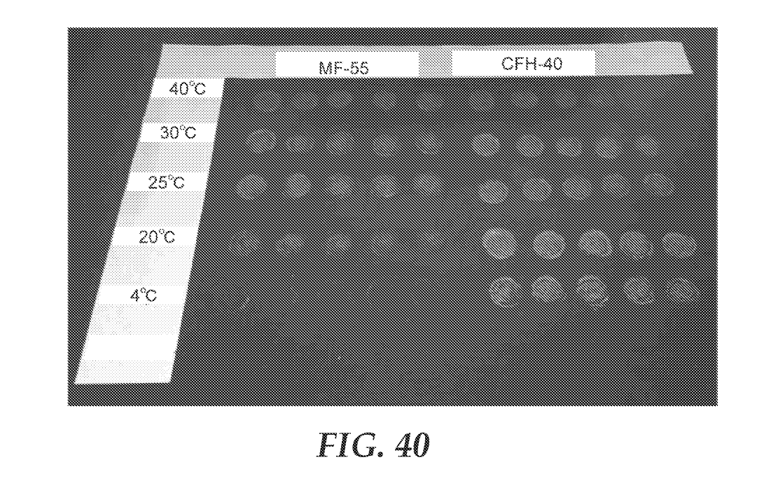

Next, using the marker composition of Working Example 22, applicator sets having MF-55 or CFH-40 as a sponge were obtained in the same manner as in Working Examples 15 and 16. Using the applicators of the obtained applicator sets, the compositions were applied five times each to black pieces of paper. The reflectivity of the marker composition and the state of the marker composition on the piece of paper at a paper temperature of 40° C., 30° C., 25° C., 20° C., and 4° C. were then evaluated in accordance with the same evaluation criteria as in Working Examples 15 to 20. The obtained results are shown in Table 13. In addition, when applicators having MF-55 and CFH-40 as sponges were used, an image of the state of a piece of paper to which the marker composition of Working Example 22 was applied, without irradiation of imaging light, is shown in FIG. 39, and an image of the state of a piece of paper to which the marker composition of Working Example 22 was applied, with irradiation of imaging light, is shown in FIG. 40. In FIGS. 39 and 40, the multiple transfers of the marker compositions when each sponge was used at each temperature were respectively made using the same applicator. There is essentially no difference between the evaluation results obtained when the applied marker composition was observed with the naked eye and the evaluation results based on photographs.

TABLE 12

| | | | Working Examples | | | | | | | | | |
|---|---|---|---|---|---|---|---|---|---|---|---|---|
| Dispersion medium | | | 21 | 22 | 23 | 24 | 25 | 26 | 27 | 28 | 29 | 30 |
| Poloxamer 188 | | | 90 | 70 | 90 | 95 | 90 | 95 | 50 | 25 | 50 | 75 |
| Pluronic P103 | | | — | — | — | — | — | — | — | 75 | 50 | 25 |
| softener | glycerin | | 10 | 30 | — | — | — | — | 50 | — | — | — |
| | PEG#600 | | — | — | 10 | 5 | — | — | — | — | — | — |
| | PPG#4000 | | — | — | — | — | 10 | 5 | — | — | — | — |
| rating | state of the composition (25° C.) | | wax | wax | wax | wax | wax | wax | wax | wax | wax | wax |
| | reflectivity | 4° C. | B | B | C | C | C | C | B | B | B | B |
| | | 20° C. | B | A | C | C | C | C | B | A | A | B |
| | | 25° C. | B | A | C | C | C | C | B | A | A | A |
| | | 30° C. | A | A | B | A | A | B | B | A | A | A |
| | | 40° C. | A | A | B | A | A | A | A | A | A | A |
| | state on the piece of paper | 4° C. | A | B | A | A | A | A | A | B | A | A |
| | | 20° C. | A | A | A | A | A | A | A | B | B | A |
| | | 25° C. | A | A | B | B | B | A | A | B | B | B |
| | | 30° C. | A | A | B | B | B | A | A | B | B | B |
| | | 40° C. | A | A | B | B | B | A | A | B | B | B |

TABLE 13

Working Example 22
sponge

| Material | | | MF-55 | CFH-40 |
|---|---|---|---|---|
| rating | reflectivity | 4° C. | B | A |
| | | 20° C. | A | A |
| | | 25° C. | A | A |
| | | 30° C. | A | A |
| | | 40° C. | A | A |
| | state on the piece | 4° C. | B | A |
| | of paper | 20° C. | A | A |
| | | 25° C. | A | A |
| | | 30° C. | A | A |
| | | 40° C. | A | A |

### Working Examples 31 through 34

### <Preparation of the Marker Composition>

In Working Examples 31 to 34, marker compositions having the compositions indicated in Table 14 were prepared using UB-35M (produced by Unitika Ltd., trade name) and the dispersion mediums of Working Example 22 indicated in Table 12. The unit of the blended fractions of each of the materials in Table 14 is parts by weight.

### <Production of Applicator Sets and Evaluation of Physical Properties of Marker Compositions>

Applicator sets were produced using the respective marker compositions of Working Examples 31 to 34. The production procedure for the applicator sets is the same as in the case of Working Examples 15 and 16 with the exception of changing the sponge to CFH-40. At this time, the retention ability of the sponge of the marker composition was evaluated in accordance with the same evaluation criteria as in Working Examples 15 and 16. Next, the temperatures of the applicators of the obtained applicator sets were set to 40° C., 25° C., or 4° C., and the marker compositions of Working Examples 31 to 34 were applied to pieces of paper. The reflectivity of the marker compositions was evaluated in accordance with the same evaluation criteria as in Working Examples 15 and 16.

Furthermore, the marker compositions of Working Examples 31 to 34 were applied to the surfaces of stainless steel materials (SUS) at 25° C. using the obtained applicators. The ease of wiping the marker compositions off the SUS surface was then evaluated in accordance with the same evaluation criteria as in Working Examples 15 and 16.

The obtained results are shown in Table 14.

TABLE 14

| | | | Working Examples | | | |
|---|---|---|---|---|---|---|
| Material | | | 31 | 32 | 33 | 34 |
| particles | UB-35M | | 60 | 70 | 75 | 80 |
| dispersion medium | | | 40 | 30 | 25 | 20 |
| rating | state of the composition | | wax | wax | wax | wax |
| | (25° C.) | | | | | |
| | retention ability | | A | A | A | B |
| | reflectivity | 4° C. | C | C | A | B |
| | | 25° C. | A | A | A | A |
| | | 40° C. | B | B | A | A |

| | | | | |
|---|---|---|---|---|
| ease of wiping off | B | A | A | A |

### INDUSTRIAL APPLICABILITY

The marker composition of the present invention and the package using the marker composition are useful for the determination of the degree of cleanliness at hospitals and other facilities, for example.

### REFERENCE NUMERALS

10 . . . package
12,22 marker composition
14,24 receiver part
16 indentation part
18 receiver part
19,48,58,68,78,88 lid part
20,30,40,50,60,70,80,110,120,130,140,150,160 applicator
26,90 lid body
28,32,42,52,62,72,82,112,122,132,142,152,162 applicator body
28a Support portion
28b application part
29 protection body
34,44,54,64,74,84,114,124,134,144,154,164 retention body
34a male thread part
36,116,126,136,146,156,166 lid body
36a female thread part
38,45,55,65,75,85,118,128,138,148,158,168 sealing component
46,56,66,76,86 retention part
100,200 applicator set
170 fixing member

1. A marker composition containing retroreflective particles and a dispersion medium,
a blending ratio of the retroreflective particles being from 50 to 90 mass % on the basis of the total marker composition.

2. The marker composition according to claim 1, wherein the dispersion medium contains water and a water soluble polymer.

3. The marker composition according to claim 2, wherein the water soluble polymer comprises a polymer soluble in both water and an alcohol; and
the dispersion medium further contains alcohol.

4. The marker composition according to claim 2, wherein the water soluble polymer comprises polyvinylpyrrolidone.

5. The marker composition according to claim 2, wherein the water soluble polymer comprises partially crosslinked polyvinylpyrrolidone.

6. The marker composition according to claim 1, wherein the marker composition further comprises a humectant.

7. The marker composition according to claim 1, wherein an average particle diameter of the retroreflective particles is from 10 to 100 μm.

8. The marker composition according to claim 1, wherein the dispersion medium is a dispersion medium soluble in water.

9. The marker composition according to claim 8, wherein a pour point of the dispersion medium is from 0 to 60° C.

10. The marker composition according to claim 8, wherein the dispersion medium contains a nonionic surfactant.

11. The marker composition according to claim 8, wherein the dispersion medium contains a nonionic surfactant and a softener.

12. The marker composition of claim 8, wherein average particle diameter of the retroreflective particles is from 10 to 100 μm.

13. A package comprising:
the marker composition OF claim 1; and
a receiver for receiving the marker composition.

14. The package according to claim 13; wherein
the receiver comprises:
a receiver part having an indentation part for receiving the marker composition, and
an openable lid part for hermetically sealing the indentation part.

15. The marker composition according to claim 3, wherein the water soluble polymer comprises polyvinylpyrrolidone.

16. The marker composition according to claim 3, wherein the water soluble polymer comprises partially crosslinked polyvinylpyrrolidone.

17. The marker composition according to claim 2, wherein the marker composition further comprises a humectant.

18. The marker composition according to claim 9, wherein the dispersion medium contains a nonionic surfactant.

19. The marker composition according to claim 9, wherein the dispersion medium contains a nonionic surfactant and a softener.

20. The marker composition according to claim 9, wherein an average particle diameter of the retroreflective particles is from 10 to 100 μm.
